(19) United States
(12) Patent Application Publication
(10) Pub. No.: US 2009/0033333 A1
(43) Pub. Date: Feb. 5, 2009

(54) APPARATUS AND METHOD FOR MEASURING PARAMETERS ASSOCIATED WITH ELECTROCHEMICAL PROCESSES

(75) Inventors: Orna Gribova, Rehovot (IL); Alexander Vol, Rehovot (IL)

Correspondence Address: OLIFF & BERRIDGE, PLC, P.O. BOX 320850, ALEXANDRIA, VA, 22320-4850, US

(73) Assignee: G.R. ENLIGHTENMENT LTD., Rehovot (IL)

(21) Appl. No.: 12/280,756

(22) PCT Filed: Mar. 1, 2006
(86) PCT No.: PCT/IL06/00284

§ 371 Date: Aug. 26, 2008

(51) Int. Cl. G01N 27/02

(52) U.S. Cl. 324/439

(57) ABSTRACT

This invention is directed to devices, apparatus, systems and methods for non-invasive sensing of activities occurring within an entity such as an organism. The method comprises sensing at least one characteristic of a current source from under the surface of the entity over a period of time; conveying at least one electrical signal corresponding to the at least one characteristic to an electrolytic cell so as to induce an electrolytic reaction over the period of time; and measuring at least one electrical output of the electrolytic reaction so as to sense at least one activity within the entity over the period of time.

### FIELD OF THE INVENTION

This invention relates to devices and methods for measuring parameters and more specifically to passive devices and methods for measuring parameters associated with electrochemical processes over time.

### BACKGROUND OF THE INVENTION

There are many devices available for directly measuring or estimating a biological being's vital physiological parameters such as blood glucose level and cardiovascular functioning and for monitoring these parameters.

U.S. Pat. No. 5,741,211 discloses a system and method for sensing and providing an indication of one or more diabetes-related blood constituents (e.g. insulin or glucose). The system is based on an ECG sensor which can be an external wearable device or an implantable one.

U.S. Pat. No. 6,022,321 describes an apparatus for detecting pulse waves and motion intensity comprising photo-coupler type photo-sensors which are attached to a biological being and provide body motion information superimposed on blood pulse signals which are analyzed by a Fourier transformation.

U.S. Pat. No. 6,334,850 discloses an optical type pulse wave device suitable for detecting a pulse waveform according to blood flow through an artery or blood vessels around the artery.

U.S. Pat. No. 6,645,142 describes a glucose monitoring instrument having network-based communication features which provide a link between patient and practitioner.

U.S. Pat. No. 6,704,588 provides an apparatus for determining a diagnostic glucose level using collimated light at a selected wavelength which computes glucose concentration based on measured polarization and the optical path length.

U.S. Pat. No. 6,675,030 discloses an individualized modeling equation for predicting a patient's blood glucose values generated as a function of non-invasive spectral scans of a body part and an analysis of blood samples from the patient, and is stored on a central computer.

U.S. Pat. No. 6,723,048 describes an apparatus for non-invasive detection and quantifying of analytes, such as blood glucose, employing an amplifier that uses high-gauss permanent magnets to permit an RF signal to be transmitted through the sample. The concentration of the analyte can be determined from the magnitude of the reduction in the amplitude of the radio-frequency (RF) signal at a characteristic frequency.

U.S. Pat. No. 6,728,560 describes an optical tissue glucose device provides a measurement of the glucose level in mucous. The instrument may comprise a radiation source capable of directing radiation to a portion of the exterior or interior surface of a patient. That surface may be a mucosal area such as the gums and other mucosal areas, the eyeballs and surrounding areas such as the eyelids and, preferably, the skin.

U.S. Pat. No. 6,920,348 discloses a system and method for determining metabolic factors using electrocardiogram measurements from a person's Wilson points. A first derivative of an electrocardiogram measurement is calculated. A ratio is calculated of the absolute value of the positive spikes of the first derivative to the sum of the absolute values of the positive and negative spikes. In some embodiments, the ratio is multiplied by a constant to determine metabolic factors. Further operations may be performed on the ratio to determine other metabolic factors. In some embodiments, a garment is provided for easily locating the Wilson points.

Electrocardiography and/or Echocardiography are also used to monitor certain health parameters and uses electrical, acoustic sensors and optical pulse wave detectors (e.g. as disclosed in U.S. Pat. No. 6,921,367, which describes estimating hemoglobin, glucose and oxygen concentrations in the blood).

U.S. Pat. No. 6,925,324 discloses a medical device and method for analyzing physiological and health data and representing the most significant parameters. Low, intermediate and high-resolution scales can exchange information between each other. The low-resolution scale represents a small number of primary elements such as intervals between the heart beats, duration of electrocardiographic PQ, QRS, and QT-intervals, amplitudes of P-, Q-, R-, S-, and T-waves. This real-time analysis is implemented in a portable device that requires minimum computational resources. In the intermediate-resolution scale, serial changes in each of the elements can be determined using a mathematical decomposition into series of basis functions and their coefficients. This scale can be implemented using a specialized processor or a computer organizer. At the high-resolution scale, combined serial changes in all primary elements can be determined to provide complete information about the dynamics of the signal. The scale can also be implemented using a powerful processor, a network of computers or the Internet. The system can be used self-evaluation, emergency or routine ECG analysis, or continuous event, stress-test or bed-side monitoring.

### SUMMARY OF THE INVENTION

This invention is directed to passive devices, apparatus, systems and methods for measuring parameters associated with electrochemical processes occurring in an entity over time. The entity, as defined within the scope of the present invention, includes, but is limited to, at least a portion of a living or dead organism, and a geological or inanimate object.

The systems and apparatus of the present invention include non-invasive devices that are placed on a surface of an entity and sense activities occurring on, within and/or under the surface of the entity. In some cases the entity is a living being or part of a living being. In some embodiments, the being is a vertebrate, such as a mammal. In some further embodiments, the mammal is human.

The devices/apparatus sense the activity/activities by means of surface electrodes and electrical measuring units connected thereto. The electrodes are adapted to sense at least one of electrical currents and/or changes in electrical currents occurring on, within and/or under the surface of the entity. In some embodiments, the electrodes sense electrical currents predominantly under the surface of the entity.

In accordance with some embodiments of the present invention, there is provided a non-invasive sensing apparatus for sensing at least one parameter of an entity, comprising:

(i) at least two surface electrodes each having a contact surface adapted to be placed on a surface of the entity at corresponding at least two separate locations and further adapted to conduct electrical signals over a period of time from the at least two separate locations; and wherein two surface electrodes of the at least two surface electrodes are adapted to sense at least one characteristic of a current source under the surface of the entity;

(ii) an electrolytic cell isolated from the surface of the entity, comprising:
an electrolyte,
two cell electrodes in the electrolyte in electrical communication with the two surface electrodes adapted to sense the at least one characteristic;
wherein the electrolytic cell is adapted to be polarized responsive to the electrical signals so as to generate an electrolytic reaction, the reaction adapted to provide at least one electrical output corresponding to the electrical signals; and

(iii) a measuring unit, connected to the two cell electrodes, adapted to measure the at least one electrical output from at least one of the two electrodes so as to sense the at least one parameter.

In some embodiments the apparatus further comprises a shunting unit adapted to provide a shunting resistance, wherein the shunting unit is coupled across the two surface electrodes adapted to sense the at least one characteristic, and wherein the shunting unit is electrically in parallel to the surface.

In further embodiments, the shunting unit comprises at least one resistor. In some cases, the shunting resistance is at least 2 kiloOhm (ΩM). In some embodiments, wherein the shunting resistance is similar or equal to a resistance of the surface between the two separate locations of the two surface electrodes.

In some embodiments, the two separate locations are at least 5 mm apart.

Furthermore, in some embodiments, the contact surface is at least 0.5 cm². In some further embodiments, the contact surface is at least 1 cm².

According to some further embodiments, the apparatus further comprises a third cell electrode, not in contact with the surface of the entity, and wherein the third cell electrode is a reference electrode.

In some embodiments, there is a reference electrode, which is adapted to provide a standard potential of the electrolyte to the measuring unit.

In some other embodiments, the two surface electrodes adapted to sense the at least one characteristic are made of different materials, and wherein these two surface electrodes are configured to form a galvanic pair.

In some embodiments, the two cell electrodes are of a first material and wherein the electrolyte is matched to the material of the two cell electrodes. In some cases, the two surface electrodes are made of a second material. Sometimes, the second material is the same as the first material.

In some embodiments, the at least two surface electrodes comprise a third surface electrode. In some cases, the third surface electrode is a ground electrode, the ground electrode configured not to be in direct electrical contact with the electrolytic cell.

In some cases, the apparatus is configured to be housed in a housing suitable for placing on the skin of a mammal. In some cases the surface electrodes are biocompatible. In some cases, the surface electrodes are made of a material selected from gold, silver, aluminum, platinum, a biocompatible semiconductor, a biocompatible metallic alloy and mixtures thereof.

In some embodiments, the measuring unit comprises at least one of a voltmeter, an A/D converter, a data acquisition card connected to a computer or processor, and an oscilloscope.

In some embodiments, the at least one electrical output is selected from a voltage, a current, a capacitance, an inductance and a resistance. In some cases, the current is at least one of a direct current and alternating current. In some embodiments, the alternating current has a frequency range of 0-30 MHz (megahertz).

In some embodiments, the at least one electrical output comprises:
a differential signal between at least one of the cell electrodes and the counter electrode; and
a differential signal between two of the cell electrodes;
a differential signal between at least one of the cell electrodes and
at least one of the surface electrodes.

The apparatus comprises, according to some embodiments an electrolyte-checking module. In some cases, the electrolyte-checking module comprises:

a first module electrode of a third material; and

a second module electrode of a fourth material; wherein the first and second module electrodes are in the electrolyte; and wherein the third and fourth material are different;

a module measuring unit in electrical communication with the first and second module electrodes; and

a resistance providing unit coupled to the first and second module electrodes; wherein the module measuring unit adapted to measure at least one of:

a) a differential signal between the first and second module electrodes; and

b) a differential signal between at least one of the first and second module electrodes and the reference electrode.

There is also provided according to some embodiments of the present invention, a non-invasive sensing apparatus for sensing at least a current source inside an entity, comprising:

(i) at least two surface electrodes each having a contact surface adapted to be placed on a surface of the entity at corresponding at least two separate locations and further adapted to conduct electrical signals over a period of time from the at least two separate locations responsive to at least one activity occurring under the surface of the entity,

(ii) an electrolytic cell isolated from the surface comprising:
an electrolyte,
at least three cell electrodes in the electrolyte, two of the cell electrodes in electrical communication with two of the at least two surface electrodes; wherein at least one of the cell electrodes is a reference electrode,
wherein the electrolytic cell is adapted to be polarized responsive to the electrical signals so as to generate an electrolytic reaction, the reaction adapted to provide at least one electrical output corresponding to the electrical signals; and

(iii) a measuring unit, connected to at least two of the cell electrodes, adapted to measure the at least one electrical output from at least two of the cell electrodes so as to sense at least the current source.

Furthermore, in accordance with some embodiments, there is provided a system for non-invasive measurement of at least one parameter of a biological entity, comprising:
1) at least one sensing apparatus as described herein;
2) a processing apparatus adapted to process' the at least one parameter measurement so at to provide at least one corresponding output;
3) a memory adapted to store at least one of:
   the at least one parameter measurement; and
   the at least one corresponding output;
4) at least one output device for outputting the at least one output.

In some embodiments, the system further comprises at least one of a contact sensor, a non-contact sensor, a pulse-wave sensor, a motion sensor, a temperature sensor, an acoustic sensor, an electromagnetic sensor, a pH sensor and a perspiration sensor.

Furthermore, in accordance with some embodiments, there is provided a method for non-invasive sensing of at least one parameter of an entity, comprising:

(i) sensing at least one characteristic of a current source from under the surface of the entity over a period of time;

(ii) conveying at least one electrical signal corresponding to the at least one characteristic to an electrolytic cell so as to induce an electrolytic reaction over the period of time; and

(iii) measuring at least one electrical output of the electrolytic reaction so as to sense the at least one parameter over the period of time.

In some cases, the entity is selected from a biological entity, a structural entity, a geological entity, a chemical entity and a material entity. In some cases, the entity is a biological entity such as a mammal.

In some embodiments, the at least one parameter is selected from a glucose level, a cardiovascular function, a blood pressure parameter, an organ function parameter, a tissue function parameter, a brain function parameter, a neural function parameter, a parameter associated with a metabolic activity, a parameter related to a limb metabolic condition, a pharmacolcinetic drug parameter, a pharmaco-dynamic parameter; a psychological condition parameter, a temperature parameter, and a combination of thereof.

In some embodiments, the method further comprises processing the at least one electrical output over the period of time so as to provide corresponding output data.

In some yet further embodiments, the method further comprises storing the corresponding output data.

In some additional embodiments, the method further comprises generating a trend of corresponding output data.

In some other embodiments, the method further comprises analyzing the trend of the corresponding output data.

In some cases the method further comprising fitting at least one of the corresponding output data and a trend of the corresponding output data to a model.

In yet some further embodiments, the method further comprises analyzing at least one statistical fit responsive to the fitting step.

In some cases, the method further comprises providing a parameter result output relating to the at least one parameter responsive to the analyzing step.

In some cases, the method further comprises activating an alarm responsive to the parameter result output.

Further, in accordance with some embodiments, there is provided a method for non-invasive measurement of at least one parameter of a biological entity, comprising:

(i) completing an electrical circuit by placing at least two surface electrodes at two separate locations on a surface of the biological entity so as to conduct at least one electrical signal from the surface responsive to at least one activity occurring on and/or under the surface of the entity and so as to generate an electrolytic reaction responsive to the at least one electrical signal in an electrolytic cell comprising:
an electrolyte;
at least two cell electrodes in electrical communication with two of the at least two surface electrodes; wherein at least one of the cell electrodes is a counter electrode; and

(ii) measuring at least one of:
a differential signal between at least one of the cell electrodes and the counter electrode;
a differential signal between two of the cell electrodes; and
a differential signal between at least one of the cell electrodes and at least one of the surface electrodes;
over a period of time so as to provide at least one parameter measurement over the period of time corresponding to the at least one activity.
and

(iii) processing the at least one parameter so as to provide at least one output relating to the at least one parameter.

In some embodiments, the measuring step is performed continuously over the period of time.

In some further embodiments, the at least one parameter measurement comprises a plurality of parameter measurements.

In yet some further embodiments, the method further comprises observing an event in the entity.

In some cases, the method further comprises measuring a plurality of post-event parameter measurements. In some cases the method further comprises comparing the plurality of post event parameter measurements with the plurality of parameter measurements so as to provide at least one event analysis for the entity.

In some embodiments, the differential signal is selected from a voltage, a current, a capacitance, an inductance and a resistance. Typically, the current is selected from a direct current (DC) and an alternating current (AC). In some cases, the alternating current has a frequency range of 0-100 MHz (megaHertz).

In some embodiments, the at least one parameter is selected from a glucose level, a cardiovascular function, a blood pressure parameter, an organ function parameter, a tissue function parameter, a brain function parameter, a neural function parameter, a parameter associated with a metabolic activity, a parameter related to a limb metabolic condition, a pharmacokinetic drug parameter, a pharmaco-dynamic parameter; a psychological condition parameter, a temperature parameter, and a combination of thereof.

In some embodiments, the two separate locations are at least 3 mm apart. In some further cases, the two separate locations are at least 5 mm apart, and in some other cases, the two separate locations are at least 10 mm apart.

Additionally, in accordance with some embodiments, there is provided a system for monitoring at least one physiological parameter of a biological entity comprising:

(i) at least one sensing apparatus as described herein for placing on the surface of the biological entity for sensing the at least one physiological parameter;

(ii) at least one transmitter for transmitting signals indicative of values of the at least one physiological parameter to a processing apparatus; and

(iii) a processing apparatus adapted to process the at least one parameter measurement so at to provide at least one corresponding output;

(iv) a memory adapted to store at least one of:
the at least one parameter measurement; and
the at least one corresponding output

(v) at least one outputting device for outputting the at least one output.

Furthermore, in accordance with some embodiments, there is provided a non-invasive sensing apparatus for sensing at least one parameter of an entity, comprising:

a first electrode of one material; and

a second electrode of a second material; wherein the first material is different from the second material; and wherein

each electrode having an exterior surface adapted to be placed on a surface of the entity at two separate locations; and

a measuring unit, connected to both electrodes, adapted to measure at least one electrical output from at least one of the two electrodes so as to sense the at least one parameter.

Also, in accordance with some embodiments of the present invention, there is provided a non-invasive sensing apparatus for sensing at least one internal parameter of an entity, comprising:

two electrodes, each having an exterior surface adapted to be placed on a surface of the entity at two separate locations, wherein the two electrodes are adapted to sense at least one characteristic of a current source under the surface of the entity;

a shunting unit adapted to provide a shunting resistance similar or equal to a resistance of the surface; wherein the shunting unit is connected to the two electrodes and is in parallel to the surface; and

a measuring unit, connected to both electrodes, adapted to measure at least one electrical output from at least one of the two electrodes so as to sense the at least one parameter.

In some cases, the two separate locations are at least 5 mm apart. Sometimes, the exterior surface is at least 0.5 cm².

In some cases, the two electrodes are made of the same material.

In some embodiments, the shunting unit comprises at least one resistor. In some cases, the shunting resistance is at least 2 kiloOhm (KΩ).

In some embodiments, the at least one electrical output is selected from a voltage, a capacitance, an inductance, a current and a resistance. Typically, the current is at least one of a direct current and alternating current. In some cases, the alternating current has a frequency range of 0-100 MHz (megahertz).

In some cases the two electrodes, adapted to sense the at least one characteristic, are made of different materials, and wherein said two surface electrodes are configured to form a galvanic pair.

Also, in accordance with some embodiments of the present invention, there is provided an array comprising a plurality of non-invasive sensing apparatuses as defined herein.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 is a simplified schematic illustration of a non-invasive sensing apparatus in accordance with an embodiment of the present invention;

FIG. 2A is a simplified schematic illustration of a non-invasive electrolytic sensing apparatus, in accordance with an embodiment of the present invention;

FIG. 2B is a simplified schematic illustration of an electrical circuit describing the electrical functioning of the sensing apparatus of FIG. 2A;

FIG. 2C is a simplified schematic illustration of a non-invasive electrolytic sensing apparatus, in accordance with a further embodiment of the present invention;

FIG. 3 is a simplified schematic illustration of a non-invasive self-checking electrolytic sensing apparatus in accordance with an embodiment of the present invention;

FIG. 4 is a simplified schematic illustration of a system comprising at least one sensing apparatus in accordance with an embodiment of the present invention;

FIG. 5A is a simplified schematic illustration of a vertical cross-section of a non-invasive electrolytic cell in accordance with an embodiment of the present invention;

FIG. 5B is a simplified schematic illustration of a horizontal cross-section of a non-invasive electrolytic cell in accordance with an embodiment of the present invention;

FIGS. 6A-6C show schematic depictions of a glucose monitoring device, viewed from the top (FIG. 6A), in cross-section (FIG. 6B) and from the bottom (FIG. 6C), respectively, according to an embodiment of the present invention;

FIG. 7 is a simplified block-diagram showing the operating logic of the glucose monitoring device of FIG. 6;

FIG. 8 is a simplified flowchart of a method for sensing and determining at least one parameter of an entity according to an embodiment of the present invention;

FIG. 9 is a simplified flowchart showing further details of step 830 of FIG. 8, of a method for sensing and determining at least one parameter of an entity, according to an embodiment of the present invention;

FIG. 10 is a simplified flowchart showing further details of step, 830, of FIG. 8, of a method for sensing and determining at least one parameter of an entity, according to an embodiment of the present invention;

FIG. 11 is a simplified diagram illustrating the measurement principles of a pulse wave and its propagation rate according to an embodiment of the present invention;

FIG. 12 is a graph showing the theoretical rate of glucose absorption as function of blood glucose and insulin levels according to a theoretical model estimation, according to an embodiment of the present invention;

FIG. 13 is a theoretical derivative rate of glucose absorption which reflects restoration rate of the metabolic equilibrium, or bio-stability, according to an embodiment of the present invention;

FIG. 14 shows the results of a theoretical model depicting the Gibb's free energy of healthy and cancer cells, according to an embodiment of the present invention;

FIG. 15 is a graph showing experimental data generated by a sensing apparatus 100 of FIG. 1 of the present invention, according to an embodiment of the present invention;

FIGS. 16A-16C are graphs showing experimental data generated by a sensing apparatus 200 of FIG. 2 in the system of FIGS. 6-7 for detecting glucose levels in different patients, according to an embodiment of the present invention;

FIG. 17 shows graphs displaying experimental data generated by a sensing apparatus 100 of FIG. 1 of the present invention, wherein the device is used to investigate limb metabolism;

FIG. 18 shows graphs showing experimental data generated by generated by a sensing apparatus 100 of FIG. 1 of the present invention, of the present invention for local metabolism disorder diagnostics;

FIG. 19 shows outputs prior to and after providing an entity with a drug, using sensing apparatus 100 of FIG. 1 of the present invention for determining at least one of pharmaco-dynamics and pharmaco-kinetics of the drug, according to an embodiment of the present invention;

FIG. 20 is a simplified flowchart showing postulated interactions between the brain and body in a mammal in response to a stimulus, according to an embodiment of the present invention;

FIG. 21 is a simplified illustration of the outer surface layers including skin of a mammal;

FIG. 22 is a simplified illustration of the action of a sensing apparatus 200 of FIG. 2 in measuring under-skin currents of a mammal; according to an embodiment of the present invention; and

FIGS. 23A-23D are graphs of outputs relating to spontaneous muscle activity recorded by apparatus 200, according to an embodiment of the present invention.

### DETAILED DESCRIPTION OF EXEMPLARY EMBODIMENTS

This invention is directed to passive devices, apparatus and methods for measuring parameters associated with electrochemical processes occurring in an entity over time. The entity, as defined within the scope of the present invention, includes, but is limited to, at least a portion of a living or dead organism, and a geological or inanimate object. The apparatuses are non-invasive devices that are placed on a surface of an entity and sense activities occurring on, within and/or under the surface of the entity. In some cases the entity is a living being or part of a living being. In some embodiments, the being is a vertebrate, such as a mammal. In some further embodiments, the mammal is human. The devices/apparatus sense the activity/activities by means of surface electrodes and electrical measuring units connected thereto. The electrodes are adapted to sense at least one of electrical currents and/or changes in electrical currents occurring under the surface of the entity.

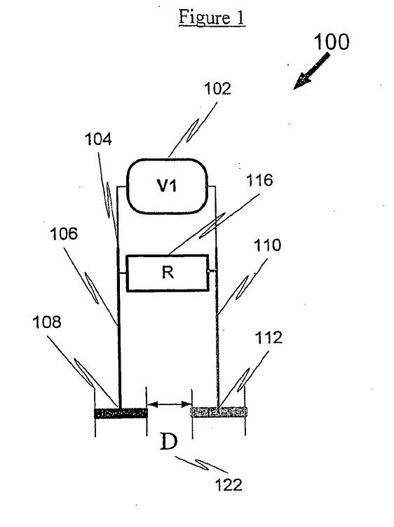

Reference is now made to FIG. 1, which is a simplified schematic illustration of a non-invasive sensing apparatus 100 in accordance with an embodiment of the present invention.

Sensing apparatus 100 comprises two surface electrodes 108 and 112. The electrodes are adapted to be placed on a surface 124 of an entity 125 at two separate locations separated by distance D. Typically the two separate locations are at least 5 mm apart. In some embodiments, D is greater or equal to 8 mm, and in some further embodiments D is greater or equal to 10 mm.

Sensing apparatus 100 comprises a shunting unit 116 adapted to provide a shunting resistance preferably similar or equal to a resistance of the surface. The shunting unit is coupled to the two electrodes and is electrically in parallel to the surface. Apparatus 100 further includes a measuring unit 102 coupled across the shunting unit. The measuring unit is adapted to measure at least one electrical output from the two electrodes so as to sense the at least one parameter. This parameter is related to processes occurring on or within the entity. Examples of the processes will be described hereinbelow.

More specifically, as is seen in FIG. 1, measuring unit 102 is connected by wired connections 106, 110 to the surface electrodes 108, 112. Surface electrodes detect electrical activity occurring on and/or under the surface of the entity. In some cases, the electrodes detect current or a change in current occurring under the surface of the entity. Shunting unit 116 is connected in parallel to the surface across wired connections 106, 110. The shunting unit is also in parallel to the measuring unit 102.

Typically, the contact surfaces of electrodes 108, 112 in contact with surface 124 can be at least 0.5 cm² each. In some embodiments, the contact surface is at least 1 cm². In some other embodiments the contact surface is at least 2 cm².

Preferably, the two electrodes are made of the same electrically conductive material. Typically the material is metallic, although semiconductors and mixtures of metal-semiconductors are also envisaged.

In some embodiments the electrical shunting unit 116, comprises at least one resistor. In some embodiments the shunting resistance is at least 2 KOhm (KΩ).

In a number of cases, the non-invasive sensing unit is used to measure the activity of a mammal, such as a human. In some cases, the surface is selected from skin, subcutaneous layers and combinations thereof.

In other embodiments, the entity is selected from a biological entity, a structural entity, a geological entity, a chemical entity and a material entity.

The measuring unit 102 comprises at least one of a voltmeter, data acquisition card connected to a computer or processor, an A/D converter, an oscilloscope or the like.

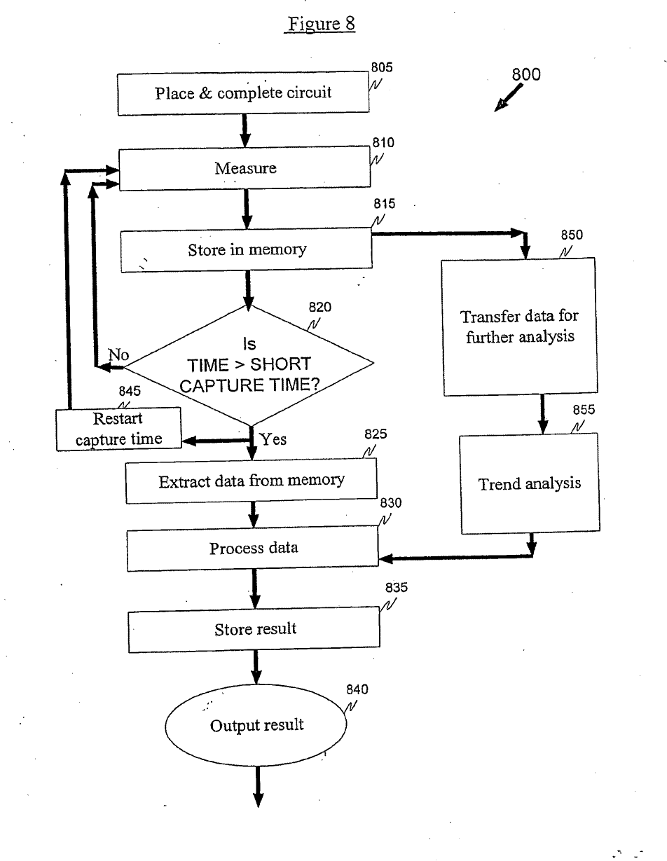

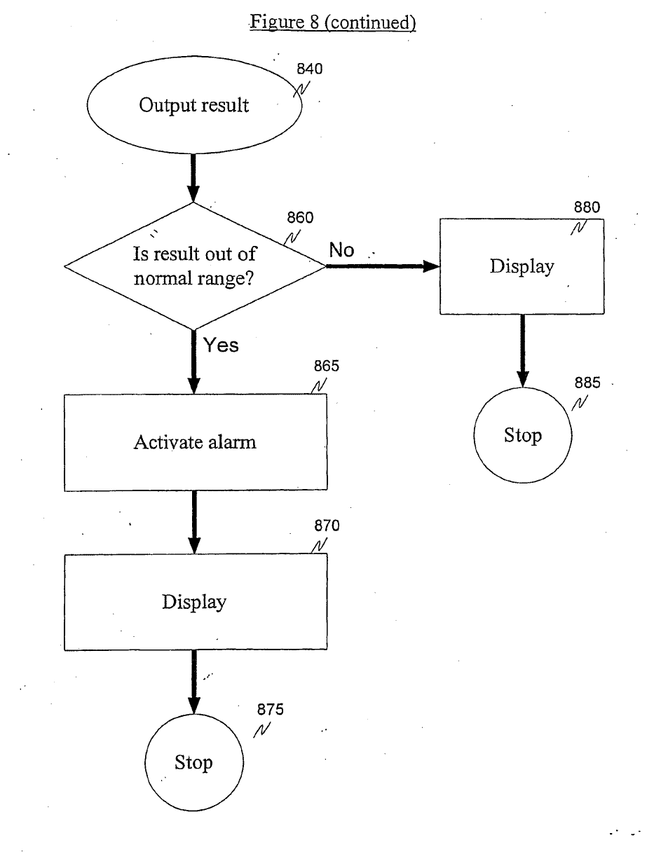

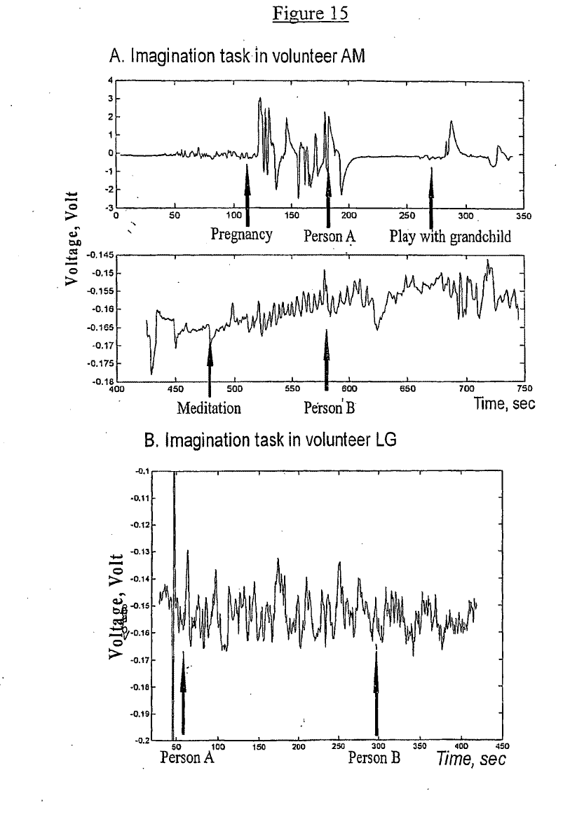

The electrical output signal originating from the surface electrodes is selected from, but not limited to, a voltage, a current, a capacitance, an inductance and a resistance. In some embodiments, the current is at least one of a direct current and alternating current. In other embodiments, the alternating current has a frequency range of 0-100 MHz (megahertz). See examples of measured electrical output signals with reference to FIGS. 15, 17-19, see also FIGS. 8-10 and Example 1 hereinbelow for further details of the present technique.

Some versions of this technology can be used for researching rotor currents, corrosion processes inside complex engineering systems, processes of interaction, etc. In some cases this resistance can be used in combination with capacitance and inductance devices.

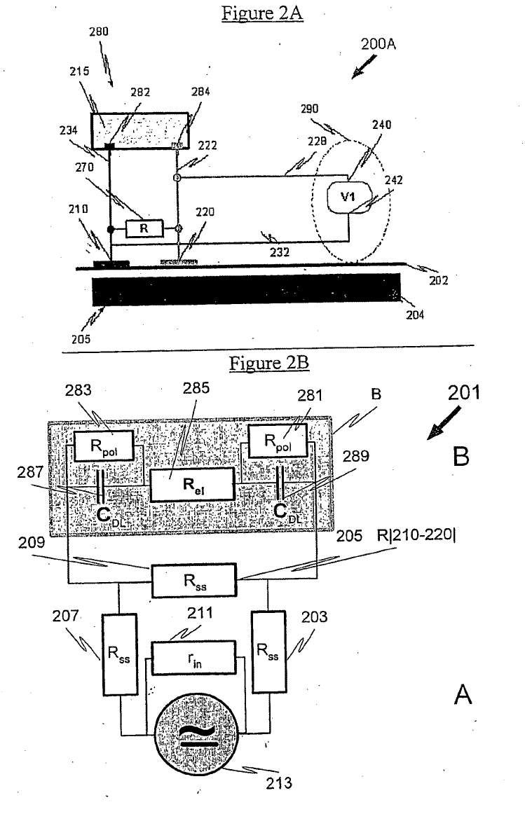

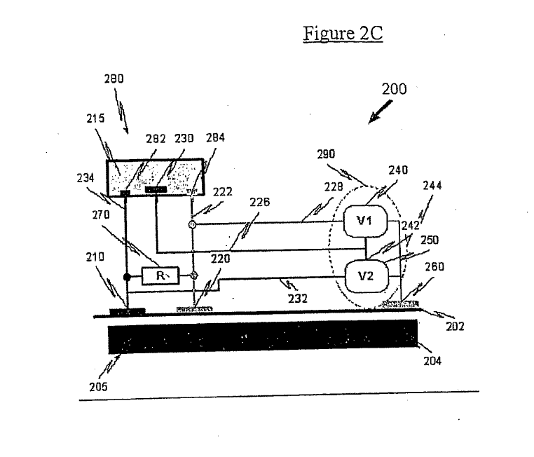

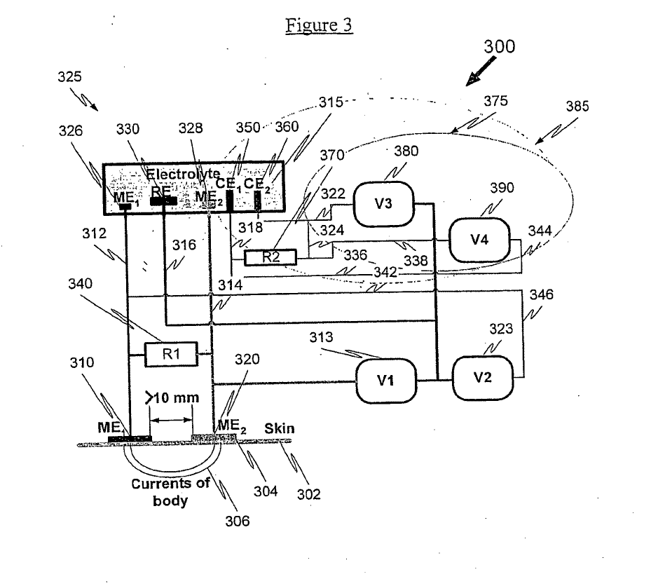

In biological systems, direct ohmic losses are absent because all electrical current in our body results from the transport or/and electrochemical processes in the living matter. In the biological case we cannot use simple resistor inductance and capacitance for modeling and estimation of electrical source. This is the reason that in this invention we propose as low impedance loading three electrodes of electrochemical cell as is described in FIGS. 2 and 3.

In FIGS. 2A and 2C, the same reference numerals indicate the same functional elements.

FIG. 2A is a simplified schematic illustration of a non-invasive electrolytic sensing apparatus 200A, in accordance with an embodiment of the present invention.

The sensing apparatus 200A is used to sense at least one parameter of an entity. Apparatus 200A comprises two surface electrodes, 210, 220 each having a contact surface adapted to be placed on a surface 202 of the entity and corresponding at least two separate locations and further adapted to conduct electrical signals over a period of time from the two separate locations. The two surface electrodes are adapted to sense at least one characteristic of a current source of processes occurring under the surface of the entity.

Apparatus 200A includes an electrolytic cell 280. The two surface electrodes are coupled to the electrolytic cell 280, which is isolated from the surface. The cell 280 comprises an electrolyte 215, two cell electrodes 282, 284 in the electrolyte, each electrode 282, 284 connected to the corresponding surface electrode 210, 220.

The electrolytic cell electrodes 282 and 284 are adapted to be polarized responsive to the electrical signals so as to generate an electrolytic reaction. The reaction induces polarization of the electrodes 282, 284 so as to provide at least one electrical output corresponding to the electrical signals.

Apparatus 200A further comprises a measuring unit 290, connected to the two cell electrodes 282, 284. Measuring unit 290 is adapted to measure the at least one electrical output from the two cell electrodes so as to sense the at least one parameter.

In some embodiments, the apparatus 200A includes a transmitting unit (not shown) coupled to the two cell electrodes 282, 284 and configured to wirelessly transmit the electrical output to the measuring unit 290.

In some embodiments, surface 202 is part of a biological entity 205, comprising surface 202 and sub-surface layers 204.

In some embodiments, the apparatus 200A preferably comprises a shunting unit 270 adapted to provide a shunting resistance, wherein the shunting unit is coupled across the two surface electrodes, 210, 220 and is electrically in parallel to the surface 202. In some embodiments, the shunting unit comprises at least one resistor or similar device. In some further embodiments, the shunting resistance is at least 2 KOhm (KΩ).

In some embodiments, the shunting resistance is preferably similar or equal to the resistance of surface 202, between the two surface electrodes. The shunting resistance is employed, inter alia, to reduce or eliminate system noise. In some cases, the system noise is static electricity, piezoelectricity and tribo-electicity of the skin.

Electrodes 210, 220 are at two separate locations, which are at least 5 mm apart. In some cases, the two separate locations are at least 8 mm apart. In further cases, the two separate locations are at least 10 mm apart. A minimal distance is required to prevent electrical interactions and interference between the electrodes.

In some embodiments, the contact surface of electrodes 210 and 220 is at least 0.5 cm² each. In some cases, it is at least 1 cm², in other cases is at least 2 cm². In some embodiments, the exterior surface is at least 20 cm².

In some embodiments, apparatus 200A comprises two cell electrodes 282, 284, which are of a first material and wherein the electrolyte is matched to the material of the two cell electrodes. For example, the cell electrodes are made of silver and the electrolyte is potassium chloride.

In some embodiments, the two surface electrodes 210, 220 are made of a second material. Typically the material is metallic (for example gold, silver and alloys) although semiconductors and mixtures of metal-semiconductors are also envisaged.

For medical applications, the second material should be a biocompatible material such as gold, platinum or silver or alloys there.

In other embodiments, the two surface electrodes 210, 220 can be used as a galvano-pair, wherein each electrode is of a different material, which can be applied to the skin to detect the sweat and skin acidity.

Apparatus 200A is used to sense at least one electrical output. In some embodiments, the output may be selected from a voltage, a current, a capacitance, an inductance and a resistance or a combination thereof. In some cases, the current is at least one of a direct current and alternating current. The alternating current typically has a frequency range of 0-100 MHz (megahertz).

Reference is now made to FIG. 2B, which is a simplified schematic illustration of an electrical circuit 201 describing the electrical functioning of the apparatus 200 of FIG. 2A. Circuit 201 can describe an equivalent scheme for, not only for biological applications, but also for geological and other applications.

Circuit 201 comprises two portions A and B. A is an equivalent scheme of skin and underlying tissues and layers (202, 204) of a living body 205, for biological applications. Portion B is an equivalent scheme of electrolytic cell 280. Portion A comprises an equivalent entity 205, equivalent skin contact resistances 203 and 207, and skin resistance 209 between electrodes 210, 220.

Equivalent cell 295 comprises two effective capacitances 287 and 289 and there between a resistance 285 of the electrolyte (215, FIG. 2A) all connected in series to resistance 209 of Portion A. These capacitances are equivalent of the double layer of the cell electrodes 282, 284 (FIG. 2A). Coupled across the two effective capacitances 287, 289 are two resistances of cell electrode (polarization) 281, 283.

The current passing through equivalent cell 295 is proportional to the total current source difference between surface electrodes 210, 220

$$\frac{{I}_{MU}}{{I}_{SL}} = \frac{{R}_{ss} 209}{{R}_{POL} 283 + {R}_{EL} 285 + {R}_{POL} 281}$$

wherein:
I_{MU} is current through equivalent cell 295, A;
I_{SL} is skin leakage current from electrode 210 to electrode 220, A;
R_{SS} is skin surface impedance 209 between electrodes 210 & 220, Ohm;
R_{POL} is electrode polarization impedance 283, Ohm;
R_{EL} is electrolyte impedance 285, Ohm;
R_{POL} is electrode polarization impedance 281, Ohm.

Reference is now made to FIG. 2C, which is a simplified schematic illustration of a sensing apparatus 200, in accordance with another embodiment of the present invention.

The sensing apparatus 200 is used to sense at least one parameter of an entity. Apparatus 200 comprises two surface electrodes, 210, 220 each having a contact surface adapted to be placed on a surface 202 of the entity at corresponding at least two separate locations and further adapted to conduct electrical signals over a period of time from the two separate locations. The two surface electrodes are adapted to sense at least one characteristic of a current source of processes occurring under the surface of the entity.

Apparatus 200 includes an electrolytic cell 280. The two surface electrodes are coupled to the electrolytic cell 280, which is isolated from the surface. The cell 280 comprises an electrolyte 215, at least three cell electrodes 282, 284, 230 in the electrolyte, two of the cell electrodes 282, 284 in electrical communication with two surface electrodes 210, 220 of the at least two surface electrodes. The electrolyte and cell electrodes are housed within a housing, 285. At least one of the cell electrodes is a reference electrode 230, not directly connected to surface 202.

The electrolytic cell electrodes 282 and 284 are adapted to be polarized responsive to the electrical signals so as to generate an electrolytic reaction. The reaction induces polarization of the electrodes 282, 284 so as to provide at least one electrical output corresponding to the electrical signals.

Apparatus 200 further comprises a measuring unit 290, connected to at least two of the cell electrodes 282, 284, 230, adapted to measure the at least one electrical output from at least one of the two electrodes so as to sense the at least one parameter.

In some embodiments, surface 202 is part of a biological entity 205, comprising surface 202 and sub-surface layers 204.

In some embodiments, the non-invasive apparatus 200 further comprises a shunting unit 270 adapted to provide a shunting resistance, wherein the shunting unit is connected to two of the at least two surface electrodes, 210, 220 and is electrically in parallel to the surface 202. In some embodiments, the shunting unit comprises at least one resistor or similar device. In some further embodiments, the shunting resistance is at least 2 KOhm (KΩ).

In some embodiments, the shunting resistance is preferably similar or equal to the surface resistance. The shunting resistance is employed to reduce or eliminate system noise. In some cases, the system noise is static electricity, piezoelectricity and tribo-electicity of the skin. All body sources cause voltage and currents perturbations between working electrodes, yet at the same time all surrounding electromagnetic noise and static electricity causes high voltage between the ground surface electrode 260 and surface electrodes 210, 220. For the neutralization of these noise effects in this invention, appropriate shunting and/or filtering units may be employed, such as unit 270.

Electrodes 210, 220 are at two separate locations, which are at least 5 mm apart. In some cases, the two separate locations are at least 8 mm apart. In further cases, the two separate locations are at least 10 mm apart. A minimal distance is required to prevent interference and electrical interactions between the electrodes.

In some embodiments, the contact surface of electrodes 210 and 220 is at least 0.5 cm² each. In some cases, it is at least 1 cm², in other cases is at least 2 cm². In some embodiments, the exterior surface is at least 20 cm². The actual impedance between the body interior resistance and the surface electrodes 210, 220 is minimal due to relatively wide electrode area of at least 0.1 cm². In sharp contrast, the size of the acupuncture points is typically less than 0.03 cm².

In some applications of the present invention, electrodes have a surface area of 0.25 cm² and are used for sensing signals in rats. Electrodes having a contact surface of around 1-4 cm² are used for sensing signals in humans. The materials of the cell electrodes in FIGS. 2A and 2C are similar or identical.

In other embodiments at least one of the at least two surface electrodes is a ground electrode 260.

In some cases, the reference electrode 230 provides a standard potential of electrolyte 215 to measuring unit 290.

The apparatus 200 is often used to sense an activity in a mammal. Typically, the unit measures activities occurring under the skin of the mammal. Apparatus 200 of this invention is typically used to measure a current under the skin of the mammal and/or a change in current under the skin of the mammal.

In some embodiments, the entity is selected from a biological entity, a structural entity, a geological entity, a chemical entity and a material entity.

In some embodiments, measuring unit 290 comprises at least one of a voltmeter, an A/D converter, oscilloscope and a data acquisition card connected to a computer or processor.

The measuring unit is used to sense at least one electrical output. The output may be selected from a voltage, a current and a resistance or a combination thereof. In some cases, the current is at least one of a direct current and alternating current. The alternating current typically has a frequency range of 0-100 MHz (megahertz).

Measuring unit 290 of apparatus 200 is adapted to measure the at least one electrical output, which may be selected from:
a differential signal between at least one of the cell electrodes 282, 284 and the counter electrode 230; and
a differential signal between two of the cell electrodes 282, 284;
a differential signal between at least one of the cell electrodes 282, 284, 230 and at least one of the surface electrodes 210, 220, 260.

See FIGS. 8-10, 16A-16C, and Example 2 hereinbelow for further details.

Measuring unit 290 comprises, in some cases, two measuring devices 240, 250 for measuring signals associated with each cell electrode 284 and 282 respectively.

The units and system described herein may be applied for monitoring the current that is accompanied with metabolite flow in electrically active and electrically inactive cells under the surface of an entity.

An additional important feature is that ratio of area of skin part electrode and electro-chemical cell part of the electrode should be at least one-two orders. Small areas of electrode parts which are inside electrochemical cells provide a small capacitance that allows detection of the high frequency signal.

Impedance between body interior and skin electrode is minimal due to relatively wide electrode area at least 0.1 cm². The characteristic size of the acupuncture points is about 1-2 mm in diameter, therefore their area is one order less then 0.1 cm². Important to mention that for the most applications, even larger electrodes may be used: 0.25 cm² for rat sensor, 1-4 cm² for human sensor.

Input impedance of at least three cell electrodes is typically about 1 kOhm, which is less then characteristic impedance of the skin which approximately 5-30 kOhm. This arrangement allows for passing of currents through the electrolytic cell. These currents may be quantified by determining/measuring polarization occurring in the cell at the electrodes.

Comparison of the electrode potential of at least one cell electrode 282, 284 versus the reference electrode 230 allows estimation of redox potential of metabolic processes inside the body.

It is important to mention that there is natural resonance of the hydrodynamic, electro-kinetic and electro-capillary processes in the body. These are exemplified, but not limited to, biological processes occurring under the skin. These processes may be in blood vessels, interstitial fluid and inside the cells. Resonance is a natural property of any living system including bio-layers. Such resonance provides a decrease of the metabolic transport losses. It leads to peristaltic activity, brain waves and similar synchronized directional processes. As a result of such self organization and synchronization processes, there is a concomitant increase of integrated current densities. These current sources are the focus of our measurements in the present invention, which are measured by apparatus 100, 200A, 200 and 300 (respectively FIGS. 1, 2 and 3) and in the methods of FIGS. 8-10 and in Examples 1-3 hereinbelow.

It is known that metabolite transport takes place in all types of living cells. Consequently, all types of cells cause formation of concentration gradients of metabolites and related metabolic products. This, in turn, leads to related electro-chemical and electro-kinetic processes. These processes provide changes in current and potential and hence, these changes may be measured and characterized.

In blood, lymph and interstitial fluid transport systems, fluid dynamic movement induce changes in local concentrations and related electrochemical and electro-kinetic processes. These processes provide changes in current and potential and hence, these changes may be measured and characterized.

However, in small vessels, such as capillaries, the mean distance between capillaries is about 50 micron. Furthermore a typical cell size is 1-100 micron. Since the size of the surface electrodes 210, 220 and 260 is orders of magnitude greater than that of the capillaries and cells, the surface electrodes therefore, measure integrated or group activities of cells and/or capillaries. Effectively, this measurement provides a smoothed out statistical mean activity, which is measured with the units and systems of the present invention as described herein.

Thus, the systems of the present invention may be used to observe and track responses to stimuli, perturbations and other disturbances induced to the body or tissue. The body or tissue response can be monitored. The frequency, amplitude and spectral characteristics and wave dynamics of the response can be analyzed and can be used to provide information regarding the status of the body or tissue. For example, see FIGS. 15, 17, 18 and 19 hereinbelow.

In this context, any living system is a thermodynamically open system, which can be stationary only if it corresponds to minimum in its Gibb's free energy. Any local perturbations are distributed at all possible degrees of freedom. In other words, it means that any local concentration or potential gradient can be detected in the surrounding tissue or organs. Thus, the present invention is directed to measuring redox potential electro-chemical reactions occurring inside a part of the body under observation. Furthermore, the systems of this invention are directed to monitoring the rate and distribution of metabolic processes by measuring their electrical current that is accompanied with metabolism of electrically active and electrically inactive cells.

Reference is now made to FIG. 3, which is a simplified schematic illustration of a non-invasive self-checking electrolytic sensing apparatus 300, in accordance with an embodiment of the present invention.

Apparatus 300 comprises an electrolytic cell 325 substantially similar to cell 280 of FIG. 2A. Apparatus 300 further comprises surface electrodes 310 and 320, substantially similar to electrodes 210 and 220 of FIG. 2A. Shunting unit 340 is similar to shunting unit 270 of FIG. 2A. Apparatus 300 further comprises an electrolyte-checking module 375. The electrolyte-checking module comprises a first module electrode 350 of a third material and a second module electrode 360 of a fourth material. The first and second module electrodes are in the electrolyte 315. The third and fourth materials are different. Apparatus 300 further comprises a module measuring unit 385 in electrical communication with the first and second module electrodes 350, 360 and a resistance providing unit 370 connected to the first and second module electrodes 350, 360.

The module measuring unit 385 is adapted to measure at least one of:
a) a differential signal between the first and second module electrodes 350, 360; and
b) a differential signal between at least one of the first and second module electrodes 350, 360 and the reference electrode 330.

The third material and the fourth material typically comprise a metallic alloy or metal. Typically there is a difference in composition of the third and fourth material so as to provide a small potential difference (see Example 3 hereinbelow).

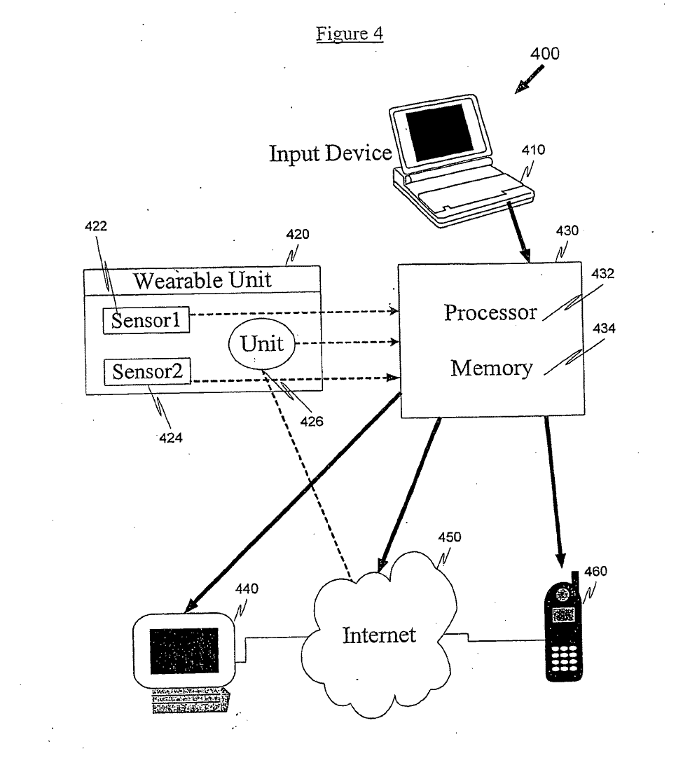

FIG. 4 is a simplified schematic illustration of a system 400.

System 400 comprises a wearable unit 420, an input device 410, a microprocessor 430, an outputting device 440, a public communication system, such as the internet 450 and a communication device such as a phone 460.

In some embodiments, wearable unit 420 consists of sensing apparatus 300 as described in FIG. 3. In some embodiments, unit 420 may be combined with other types of standard sensors, such as a thermal sensor 422, accelerometer 424, a microphone (not shown) or other sensors known in the art. In alternative embodiments, unit 420 is not wearable.

Sensing elements 422, 424, and unit 426 are typically connected to at least one apparatus 430 comprising at least one programmable microprocessor 432 and at least one memory 434. The apparatus may be close to or distant from the body, having wired or unwired connections therewith, as is known in the art, such as standard existing technology like Infra-red technology used for computers, ultrasound technology used for home devices or any other known in the art. In addition, to input from the sensing system 420, the microprocessor can get additional input from one or more inputting devices 410, which are located near to or distant from wearable unit 420. The inputting device 410 can be used for inserting personal information like time, dosage and kind of medication, supplement or food intake; necessary results from laboratory or ambulatory examination; correction of output regimen and format, etc.

In some embodiments, the apparatus 426 comprises at least two electrodes, for placing on a surface of a body. In some embodiments, the electrodes may be in a bracelet or watch arrangement, may be in pads or in a waistcoat, trousers or any other piece of clothing, footwear, headwear, jewelry, bedclothes, or the like. In other embodiments, the electrodes may be in a stand alone device.

Microprocessor 430 may be replaced by any other type of computer having a processor 432 and at least one memory 434.

The output of the microprocessor 430 may be communicated to any outputting device 440 located near to or distant from the sensors 440, or can be transmitted to a cellular phone 460 or to the internet 450, interactive TV (not shown) or to any other communication system known in the art.

The measuring/sensing units (with reference to the figures) described herein may be employed to measure a large number of different parameters, such as, but not limited to, those described herein.

System 400 may be used for many different applications, such as monitoring metabolism and body reactions or processes. Some examples include, but are not limited to:

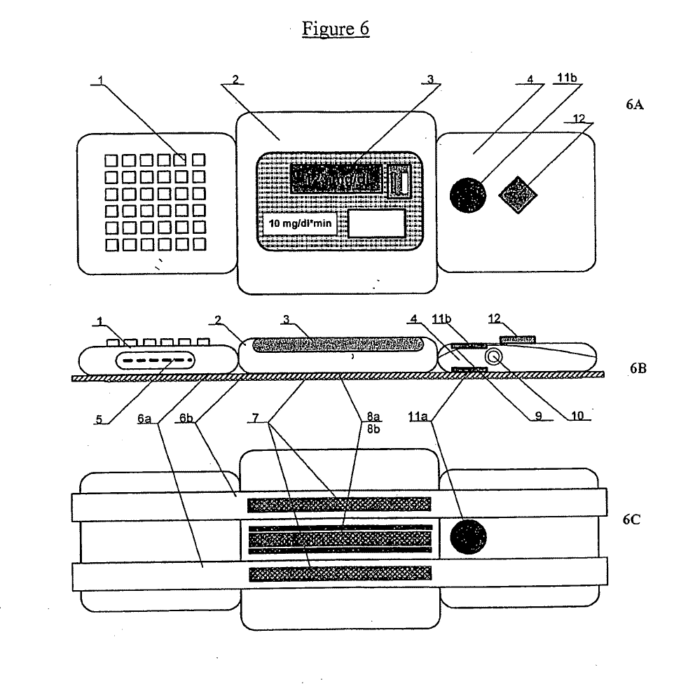

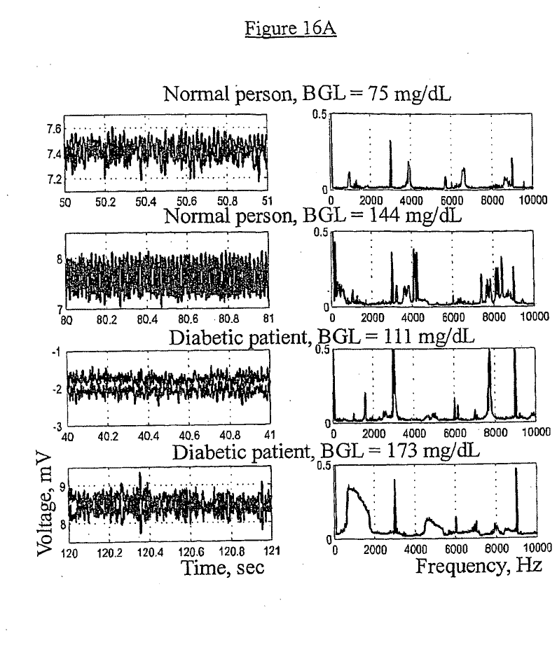

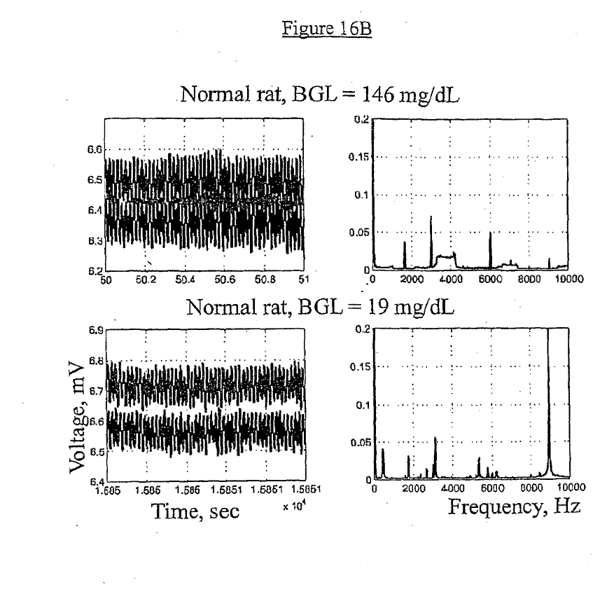

a) Glucose Level Monitoring (for Further Details See FIGS. 16a-16c, 6,7).

For glucose monitoring, the wearable unit 420 comprises a sensing apparatus 200 or 300 and a sweat detector known in the art.

Note: here and below the apparatus 300 can, for some applications, be replaced by simpler apparatus such as apparatus 100 and apparatus 200. In some embodiments, apparatus 300 is preferred to the simpler apparatus as it is fully self-contained. In some cases, apparatus 300 can be replaced by its multi-array modification 500.

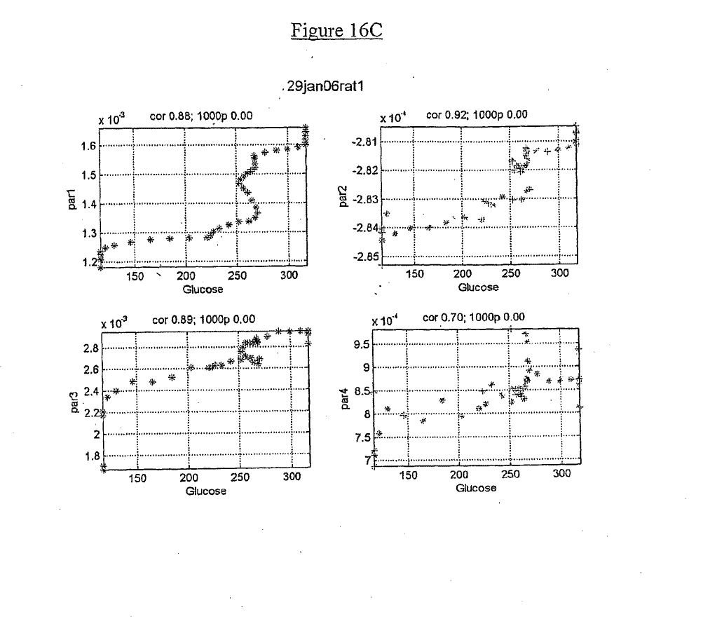

b) Limb Metabolism or Limb Blood Supply Monitoring (Exemplified in More Detail in FIG. 17):

For monitoring limb metabolism, wearable unit 420 comprises a sensing apparatus 200, 200A or 300, as well as a thermo sensor-main and optionally a pulse wave sensor (acoustic sensor—for each measured limb).

c) Wireless ECG

For wireless ECG monitoring, five sensing apparatus 200, 200A or 300-one near heart and four for all limbs are required. It may be possible to decrease this number to 1 or 2 in the future.

In addition, it is possible to have a contact less sensor of any electrical or magnetic field. In addition, it is possible to add another sensor of a totally passive chemical material (nano-technology powder) which will not have direct contact with the skin, but will provide high impedance and will reduce the danger of having a stroke due to adsorption of the increased electromagnetic energy. Additionally, ECG monitoring device could be combined with a bio-feedback “relaxometer” (described hereinbelow) for monitoring a nervous system state in parallel to cardiovascular state.

d) Blood Pressure Monitoring

For monitoring of blood pressure, the monitoring unit comprises at least one sensing apparatus 300 combined with pulse wave sensor, and optionally a thermosensor or acoustic sensor.

e) Blood Viscosity Monitoring

For blood viscosity monitoring, the monitoring unit comprises, at least one sensing apparatus 300 and at least two pulse wave sensors.

f) Peripheral Nervous System (PNS) Monitoring (Including Measuring Symapathetic/Parasympathetic Index) Monitoring

For PNS monitoring, the monitoring unit comprises, for example at least one sensing apparatus 300.

g) Central Nervous System (CNS) Monitoring

For CNS monitoring, the monitoring unit comprises for example at least several sensing units 300 and at least one acoustical sensor for placing on the scalp. It is preferable to use combined nervous system monitoring employing f) and g) together.

h) Local Metabolism Monitoring, Organ/Tissue Functional Monitoring (Exemplified in More Detail in FIGS. 17, 18 and 19).

For local metabolism monitoring, organ/tissue functional monitoring apparatus comprises at least one sensing apparatus 300 or multi-array 500.

Inflammation can be observed in addition to other metabolic processes as it is accompanied with metabolism change. In order to make a monitor, at least one sensing Apparatus 300 is employed, though multi-arrays 500 are also envisaged.

The sensing apparatus 300, 500 can be combined with thermosensors, pulse sensors, acoustic sensors or any other physiological sensors known in the art.

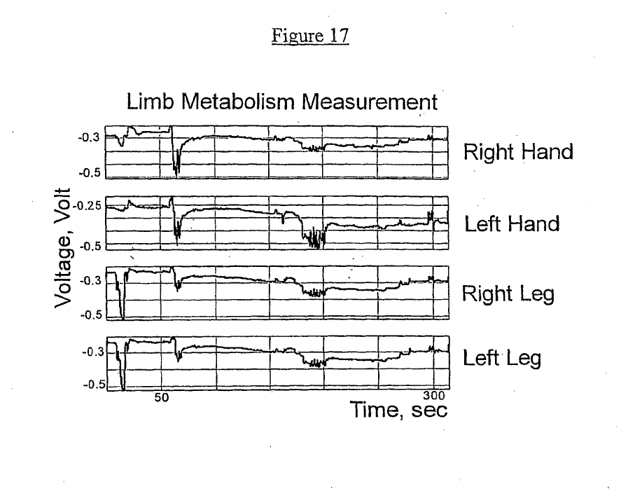

i) Cancer Diagnostic Monitoring (CDM) (Exemplified in More Detail in FIG. 18).

For cancer diagnostic monitoring, similar to local metabolism monitoring, the monitoring unit comprises at least one sensing apparatus 300 or multi-array 500, which can be combined with thermosensors, pulse sensors and acoustic sensors.

CDM may include cancer/tumor size estimation; characterization of a tumor or cancer is metastatic or not, polymorphic or monoclonal; estimation of its growth dynamics and other similar applications of the art.

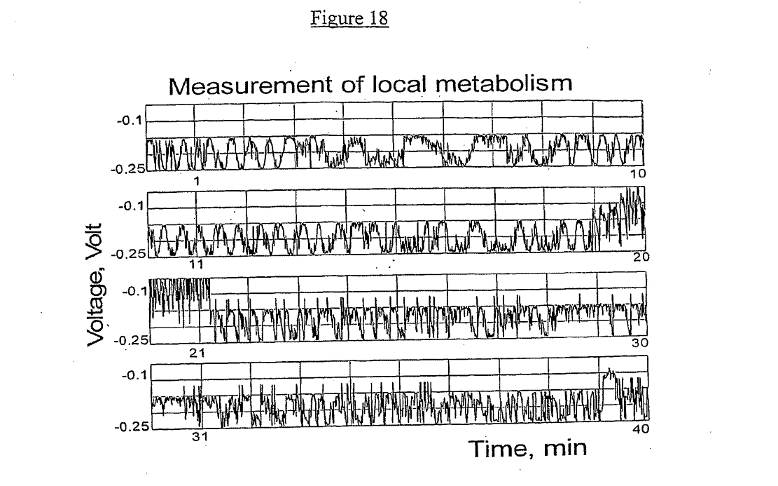

j) Drug and Active Material Metabolism Monitoring (Exemplified in More Detail in FIG. 19):

For drug and active material metabolism monitoring, the wearable unit 420 comprises one or more sensing apparatus 300 or multi-arrays 500 placed according to where and how wide the stimuli work. Unit 420 can be combined with CNS & PNS monitoring, local metabolism monitoring and cardiovascular monitoring. Unit 420 can also be combined with thermosensors, pulse sensors and acoustic sensors. Combination of sensing apparatus 300, 500 together with CNS monitoring wearing unit described above allows the tracking the blood brain barrier penetration.

k. Psychological Detector, Lie Detector (Exemplified in More Detail in FIG. 15).

The apparatus may be applied to check psychological status, lie detection, checking self-confidence with respect to certain decisions or thoughts and psycho-immune status. The apparatus can also be used to check “search activity” to improve treatment or surgery. It can further be used for self training. The apparatus can further be applied to check psycho-status of people having high responsibility work (pilots, nuclear station workers etc) and can be used during their training. The apparatus can be used for potential terrorist detection. These kinds of applications are termed herein “psychological monitoring”.

For “psychological monitoring” the wearable unit 420 typically comprises at least one sensing apparatus 300 probably combined with multi-array 500. The apparatus is placed on the body of a person in accordance with the type of response to be detected, in response to one or more stimuli under observation. Sensing Apparatus 300 can be combined with CNS & PNS monitoring, local metabolism monitoring and cardio-vascular monitoring. Additionally, the apparatus can be combined with thermosensors, pulse sensors, acoustic sensors, optotrack, or any other sensors known in the art.

l) Chakra Acupuncture, Meridian Diagnostics

For chakra, acupuncture and meridian diagnostic monitoring, the module 420 may comprise a multi-array measuring apparatus 500, which can be combined for example with acoustic sensors, thermosensors and pulse sensors.

It should be noted that all of the above medical or physiological applications can be closed as a bio-feedback devices for self use, medical diagnostic devices or life guard with alarm for the different physiological systems.

m) Material Quality Check and Corrosion Detection. Applications for Geology and Earthquake Early Detection

For material properties, corrosion detection or applications in geology and earth quake at least on apparatus 300 may be used. For these non-biological applications the materials and electrolyte solution may be adapted to the measured substances.

The sensing apparatus can be used in geology including earthquake early detection, material quality check, estimating life span for old buildings. This takes into account that inside the entity there are reversible and/or irreversible processes taking place that are accompanied by electrolytes, solid mass, liquid and/or gaseous flows which induce electrical perturbations, detectable by the apparatus of the present invention.

For researching of the geochemical processes that take place in hydro-thermal solutions or in the mineralization zones, electro-chemical cells, such as those depicted in FIG. 2 and FIG. 3 can be used. In some cases, the electrolytic cell comprises copper electrodes in a sulfate solution, in combination with different types of metal electrodes for insertion into earth or rock, accelerometers and antenna devices. Such combinations allow the measurement of galvanic currents parameters and variability thereof.

In some cases, these geochemical processes are accompanied with processes of stalactites and stalagmites growths, mine formation, and also precursor processes of earthquakes and eruptions.

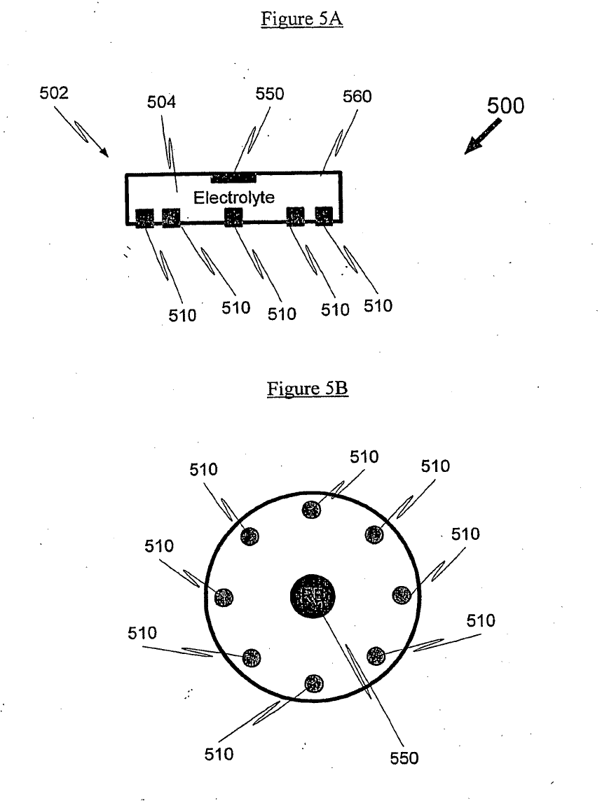

Reference is now made to FIG. 5A, which is a simplified schematic illustration of a vertical cross-section of a non-invasive electrolytic cell array 500 in accordance with an embodiment of the present invention. Array 500 comprises an electrolytic cell 502 having an electrolyte 504, a reference electrode 550 and a plurality of cell electrodes 510. The plurality of cell electrodes 510 are all immersed in the same cell. This arrangement enables both the quenching of noise and multidimensional measurement. Similarly to electrolytic cells of FIGS. 2 and 3), the cell electrodes 510 may act as measuring and/or counter electrodes and have an outer surface made from the same material, which is not shown in this figure and electrolyte cell part (560, 510, 550).

Advantageous properties of arrays include, for example, but are not limited to:

a) mutual inter-polarization of each pair of electrodes 510 and of all of the electrodes together;

b) applying several relatively wide skin electrodes 510 to a surface decreases the total system resistance, and therefore improves signal to noise ratio; and

c) simultaneous measurement of each of several electrodes versus the same reference electrode 550 enables one to obtain more detailed physiological parameters monitoring in time and in space with a higher accuracy.

FIG. 5B is a simplified schematic illustration of a horizontal cross-section of a non-invasive electrolytic cell 500 in accordance with an embodiment of the present invention. It can be seen that the array of cell electrodes 510 is organized around the central reference electrode 550.

FIG. 6 shows schematic depictions of a glucose monitoring device, viewed from the top, in cross-section and from the bottom, respectively, according to an embodiment of the present invention;

Referring to FIG. 6, there is shown a first embodiment of the present invention, adapted for glucose determination/monitoring, illustrated by a wrist watch or wristlet comprising three types of sensors: pulse-wave sensors 6a and 6b based on piezo-electrical sensors (Samsung or Motorola), biocompatible electrodes, biocompatible electrodes 7 made from pure silver 99.99%, and additional biocompatible electrodes 8a and 8b and estimating the acidity thereof, made from pure silver and silver-platinum alloys 90% and 10% respectively.

The device comprises the following electronics: a keyboard 1, a body 2 with a display 3 and an electronic block 4. The keyboard 1 is supplied with a connector 5 to allow connection of a programmed cartridge, for example a home computer, cellular phone, palm-sized electronic notebook, etc (not shown). The body 2 incorporates the pulse-wave sensors 6a and 6b, biocompatible electrodes 7, and additional biocompatible electrodes 8a and 8b.

Electronic block 4 is supplied with an antenna 9 and a connector 10 for transferring data and/or an alarm signal through an external transmission-connection unit (not shown), (e.g. telephone line, fax, the Internet) for sending such data to a physician.

The device also includes two thermometers 11a and 11b for measuring the patient's skin and the surrounding temperature, respectively, and a 3-dimensional accelerometer 12 for measuring motion intensity or physical activity of the hand (not seen).

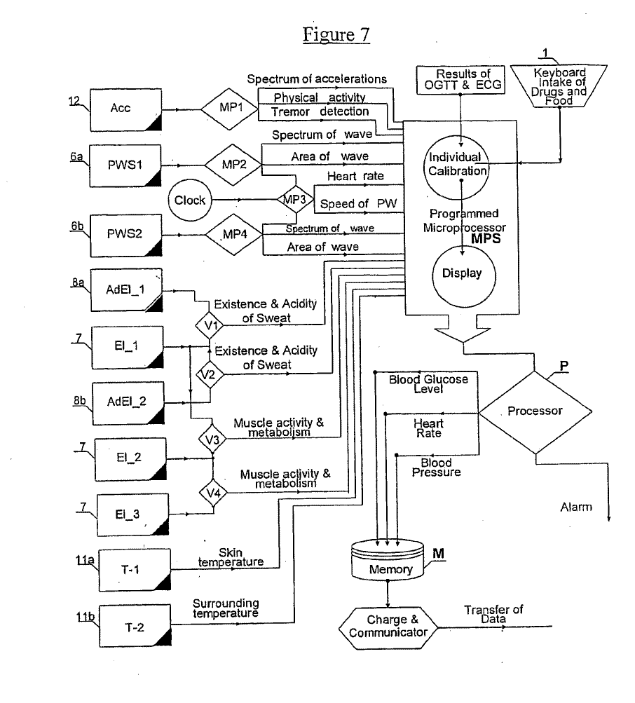

FIG. 7 is a simplified block-diagram showing the operating logic of the glucose monitoring device of FIG. 6 and showing the operative connections between components of the device.

The following components are shown and labeled as indicated:
The two pulse-wave sensors 6a and 6b (PWS1 and PWS2), which are connected to a microprocessor (MP 6).
three electrodes 7 (E1_1, E1_2 and E1_3), where electrodes E1_1, E1_2 are electrochemically connected to electrode E1_3, which is a reference electrode (not seen in FIGS. 1-6 as it is inside the electronic block 4). The three electrodes 7 (E1_1, E1_2 and E1_3) are connected to three voltmeters V2, V3 and V4, respectively. In order to measure DC and AC voltages it is necessary to use the two separate voltmeters. Therefore the signal from the E1_1 goes to V1 to measure acidity, to V2 to measure DC and to V3 to measure AC.
The two perspiration measuring electrodes 8a and 8b (AdE1_1 and AdE1_2), which are each connected with a voltmeter (V1, V2), respectively;
The 3-dimensional accelerometer 12 (Ace).
Two thermometers 11a and 11b (T-1 and T-2) for measuring skin and surrounding temperature, respectively.
Four microprocessors (MP1, MP2, MP3, MP4); and the programmed microprocessor MP6 connected to the keyboard 1; and a processor, MP5, with memory M connected thereto; and having a charge-connector unit and alarm system.

Note, the voltmeters and microprocessors referred to herein are not seen in FIG. 6 and so are not given reference numerals (merely labels as seen in FIG. 7), however, they are located within the electronic block 4.

The microprocessor MP1 is connected with PWS1 and it analyzes pulse-wave spectral characteristics using a standard mathematical software program package (e.g. Matlab or other software). The microprocessor MP2 is connected to PWS1, PWS2 and a timer/clock, and it measures a pulse wave propagation velocity and heart rate. The microprocessor MP4 is connected to PWS2 and it analyzes a pulse wave spectrum, for example using Matlab. Examples of results of such analysis are shown in FIGS. 16A-16C. Generally, the whole process data acquisition, processing and outputting is described in more details by FIGS. 4, 8, 9, 10.

The above microprocessors MP1, MP2 and MP4 are connected with a programmed microprocessor MP5 having a display. The potential difference between electrodes 8a and 8b (AdE1-1 and AdE1-2) is proportional to the perspiration's acidity.

FIG. 8 is a simplified flowchart 800 of a method for sensing and determining at least one parameter of an entity according to an embodiment of the present invention.

In a first step, 805, a unit such as Apparatus 300 is placed on a surface so as to complete a circuit. The unit is typically part as a system such as system 400 of FIG. 4. The completion of the circuit induces an electrolytic reaction in an electrolytic cell, such as cell 280 or cell 325.

Thereafter, in a measuring step 810, a change in at least one measurable electrical parameter is measured by measuring unit 290, 375.

The measurements from step 810 are then stored in at least one memory in storing step 815. The memory for example, is memory 434.

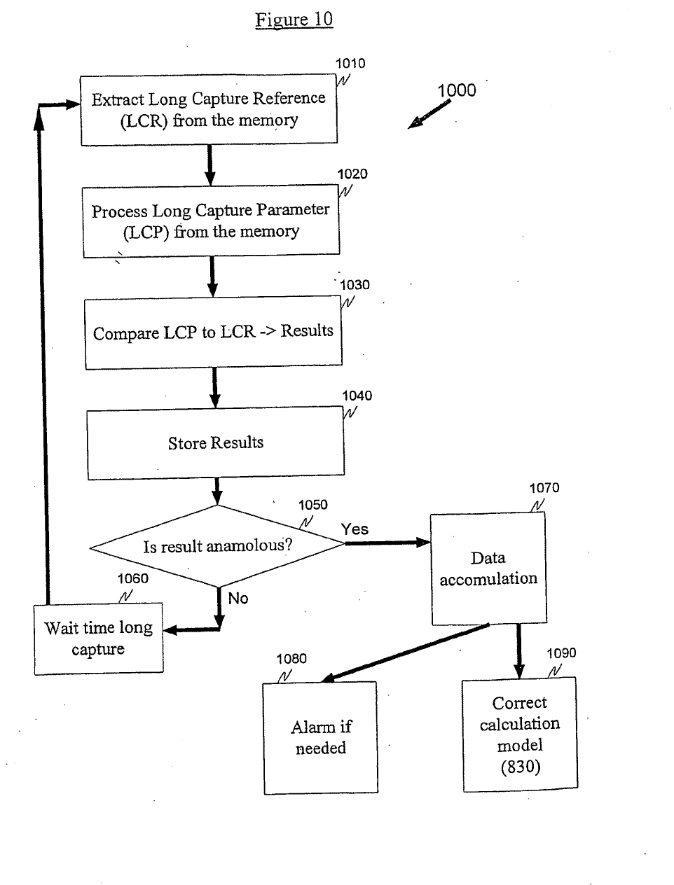

In parallel to step 815, the data is transferred in a transferring step 850 for further analysis and to trend analysis step 855 (see FIG. 10 for further details).

In a first checking step 820, it is determined whether the time elapsed is greater than a predetermined short capture time Cₜshort. If negative, the system continues to measure the parameters in measuring step 810. If affirmative, the system proceeds onto extracting step 825. In extracting step 825, the values of that parameter for time=Cₜshort are extracted. This checking step can be applied to a large number of parameters and to different predetermined capture times.

In a longer loop, it is determined whether the time elapsed is greater than a predetermined long capture time the time Cₜlong. If affirmative, the system proceeds to step 845 and the capture timing is started again.

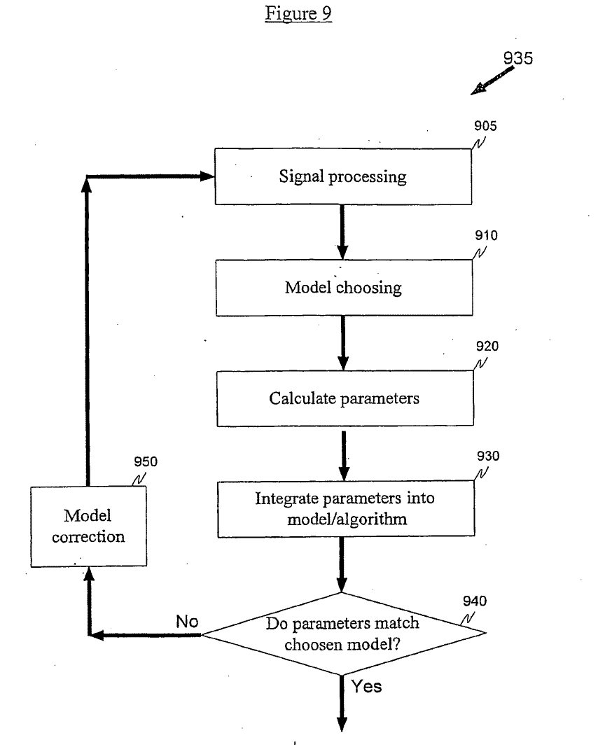

Thereafter in a processing step 830, the values of that parameter for the predetermined period of time, whether long or short are processed. Further details of this step are shown in FIGS. 9-10.

The outputs of the processed data of step 830 are then stored in storing step 835 in at least one memory, such as memory 434.

In an outputting step 840, the results from step 830 are outputted to at least one of device 440, phone 460 and device 410. Additionally or alternatively, the output may be stored or relayed to a remote location.

In a second checking step 860, the output results from step 840 are checked to see if they fall within a predetermined range. If affirmative, the results are displayed in display step 880. If negative, an alarm is activated in an activating alarm step 865.

Thereafter in a displaying step 870, the out of range results are displayed on one or more displays 440 (FIG. 4).

Reference is now made to FIG. 9, which is a simplified flowchart 935 showing further details of step 830 of FIG. 8, of a method for sensing and determining at least one parameter of an entity, according to an embodiment of the present invention.

In a signal processing step 905, a number of measurements taken over a period time for a certain parameter are processed. The time period is determined for each parameter and type of application independently according to the specific time constants for that parameter and application. The time period may be very short, such as a number of seconds up to a continuous measurement over a long period of time.

The output of step 905 is fed into one or more models in a second processing step 910. This step is a model choosing step in which the output of step 905 is compared to one or more models to find a best model.

In a calculating step 920, the best model is applied to the output of step 905 so as to provide a second output.

In an integrating step 930, the second output is fed into a second model or algorithm and a third output is produced.

In a checking step 940, the fit of the third output is compared to a set range. If the fit is sufficiently good, then the model is accepted. If not, then the model is corrected in step 950 and further data is introduced to the model in step 905.

Flowchart 935 may comprise one or more self-learning neural network algorithms known in the art.

FIG. 10 is a simplified flowchart 1000 showing further details of step 855, for trend analysis according to an embodiment of the present invention.

In a first extracting step 1010, data (long capture time reference, (LCR)) accumulated over a long capture time Cₜlong is extracted from the system memory.

In a processing step 1020, the data of long capture parameter (LCP) from memory accumulated over Cₜlong is processed to analyze at least one trend over time period Cₜlong or over a longer time period than Cₜlong.

In a comparing step 1030, LCP is compared with LCR and a comparison result (CR) is outputted.

In a storage step 1040, CR is stored in one or more system memories.

In a checking step 1050, the CR is checked to see if it fits within a desired range or limits. If the result for CR is out of range, then the system proceeds to a waiting step 1060, in which the system waits for a long capture time Cₜlong until further data is accumulated.

If the CR fits the model then, then the system proceeds to step data accumulation step 1070. In this step the data is accumulated in a trend model and/or trend database store.

In a model correction step 1090, the accumulated data from step 1070 is applied to one or more models so as to impact on the existing model or models.

In parallel, in an alarm step 1080, an alarm is set off if the accumulated data shows a significant anomaly.

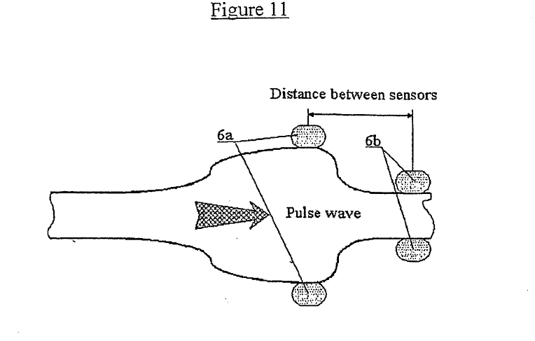

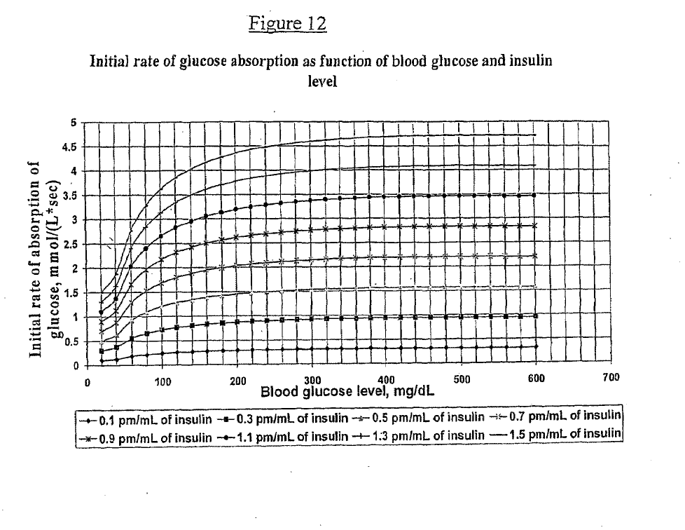

FIG. 11 is a simplified diagram illustrating the measurement principles of a pulse wave and its propagation rate used in the present invention;

With reference to FIG. 11, the principles of pulse wave measurements use the following principles:
1. The rate of movement of the blood can be estimated by the rate of pulse wave propagation between sensors 6a and 6b.
2. The blood flow is proportional to the cross-section of arteries and the velocity of the blood.
3. Blood viscosity affects the shape of the pulse waves, the rate of their propagation and the pulse wave spectrum.

The following data are supplied to the programmed microprocessors from the various sensors:

1. Pulse wave area from PWS1,

2. Pulse wave spectrum from PWS1,

3. Pulse wave area from PWS2,

4. Pulse wave spectrum from PWS2,

5. Pulse wave propagation velocity,

6. Heart rate,

7. Indication of existence of perspiration, and

8. Acidity of perspiration.

For calibration purposes, the first data are compared in the programmed microprocessor MP5 with parameters (i.e. glucose level, blood pressure, heart rate, etc.) that were recorded in the processor's memory M during an oral glucose tolerance test (OGTT) and/or during an electrocardiogram (ECG) stress test. The results of such a calibration are input into an individual “mathematical model” resulting from an individual calibration with neural network software. Similar neural network software is used to estimate the following important parameters:

1. Blood glucose level,

2. Heart rate,

3. Blood flow,

4. Blood pressure,

5. Blood viscosity (which may be affected by dehydration).

The programmed microprocessor MP5 displays selected parameters on the display 3. It is connected with a processor P that can produce an alarm if selected parameters are beyond predetermined limits, which depend on the rate of change of the parameters.

The alarm (and parameters) may be transmitted through a cellular telephone or other means of communication. All of the parameters are periodically recorded in the memory M in case any deviations, for example, they may be transmitted daily into the computer of a physician, medical center, clinic, etc, through a separate charge-connection unit.

FIG. 12 is a graph showing the theoretical rate of glucose absorption as function of blood glucose and insulin levels according to theoretical model estimation, according to an embodiment of the present invention.

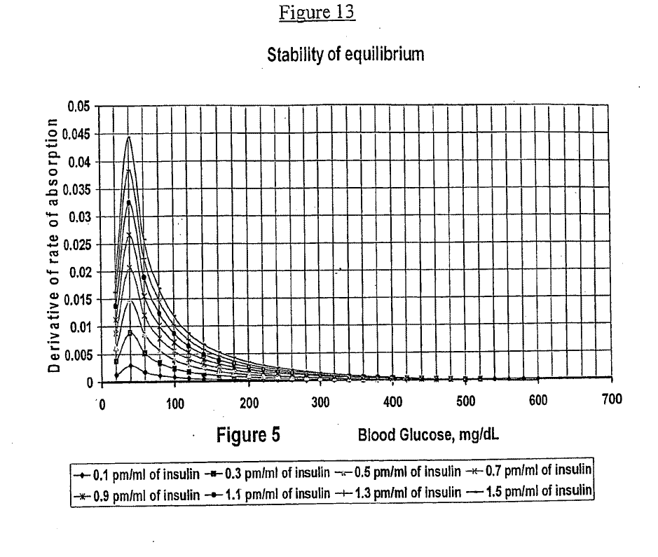

In FIG. 12, there is shown the change of the rate of cellular glucose absorption as a function of the blood glucose level at a range of insulin levels (picomoles/ml). As it can be seen, the rate of glucose absorption depends on glucose and insulin blood level. Additionally, one should mention that the maximal rate of glucose absorption is typically in a BGL range of 65 to 115 mg/dL, which corresponds to the maximal stability of the glucose level and more particularly to the maximal motion force and rate of return to equilibrium (as seen in FIG. 13).

FIG. 13 is a theoretical derivative rate of glucose absorption which reflects restoration rate of the metabolic equilibrium, or bio-stability, according to an embodiment of the present invention.

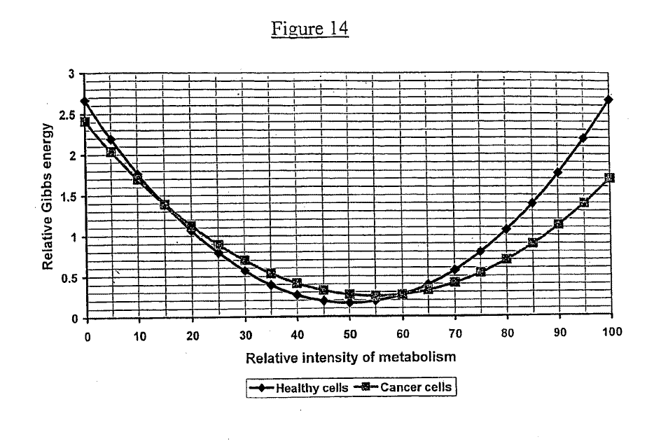

Preliminary examination of the other components of the device consisted of checking pulse-wave and bio-electricity diagnostics. The above-described theoretical basis of such diagnostics is explained with reference to FIGS. 12-14. Data for FIGS. 12 and 13 were generated from the Michaelis-Menten equation and the data for FIG. 14 were generated from the Lipman equation and electro-capillary curves.

The change of the rate of cellular glucose absorption as a function of the blood glucose level at a range of insulin levels (picomoles/ml) is shown in FIG. 12. The rate of glucose absorption depends on glucose and insulin blood level. The dominant parameter of any living system is metabolism, which includes in particular the equilibrium between carbohydrate metabolism and oxygen/carbon dioxide use and production.

FIG. 14 shows the results of a theoretical model depicting the Gibb's free energy of healthy and cancer cells, according to an embodiment of the present invention;

The function of Gibb's energy of healthy cells is indicated by diamond symbols while Gibb's energy for cancer cells is indicated by square symbols. The relative Gibbs energy is relative to the average Gibbs energy of the cells; and the relative intensity of metabolism is relative to the 50% level of the normal basic metabolism value. Metabolism measurements, which are measurable using apparatus 300, 500 of the present invention, can provide estimation of cellular Gibb's energy and thus can provide important information in the treatment of cancer.

The Gibb's energy is dependent on the relative intensity of the metabolism. It shows that in the condition of both a metabolism that is too low or too high, the Gibbs energy of cancer cells is lower than that of healthy cells. Under this condition the rate of cancer cell division may be much higher than in healthy cells.

Furthermore, the separation between the curves in FIG. 14 shows that there is a Gibb's energy difference between cancer and healthy cells which allows the estimation of polymorphism of the cancer cells. The tendency for polymorphism is proportional to the difference in the Gibb's energy between the cancer cells and the healthy cells. Cancer polymorphism itself is a very important property of the cancer cells which directly affects treatment protocol decisions and the potential effectiveness of cancer treatment.

FIG. 15 is a graph showing experimental data generated by a sensing apparatus 100 FIG. 1 of the present invention adapted to function as a “psychological monitoring”, according to an embodiment of the present invention.

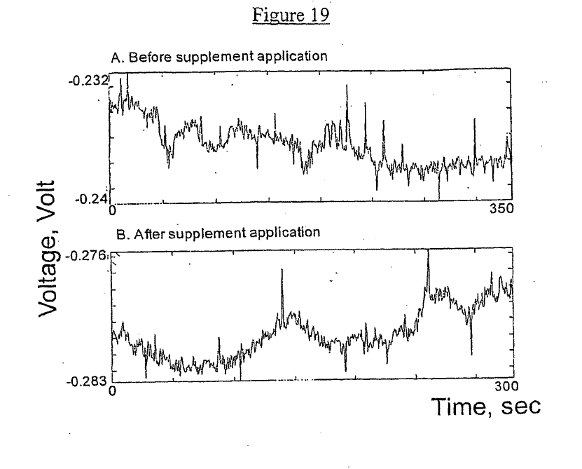

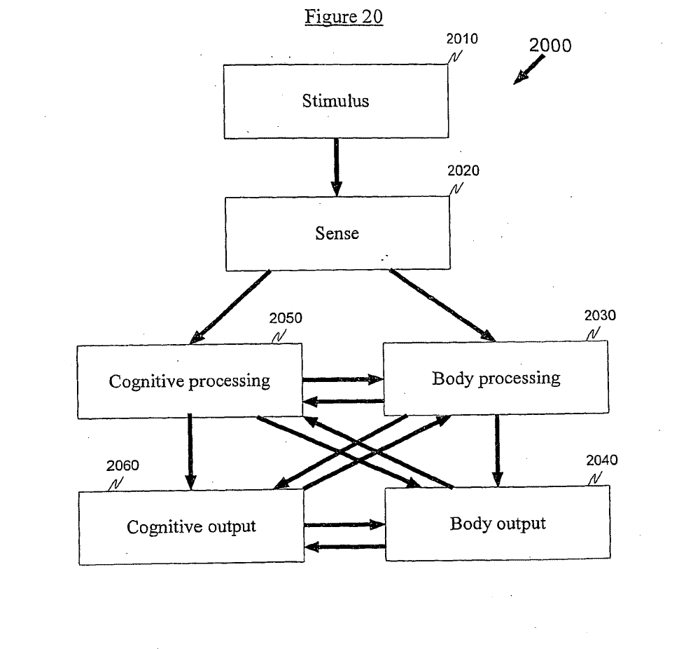

This figure shows the results of a further experiment measured by sensing unit described in FIG. 1. This experiment based on theoretical model of brain body analog circuit described in details by FIG. 20.

This experiment involved two female volunteers (volunteer AM, aged 63 and volunteer LG, aged 56). The each volunteer was connected to the sensing apparatus described in details in FIG. 1 and arranged as a bracelet device on the right hand, in the supine position to avoid uncontrolled movement. During the measurements the volunteer was asked to recall different situations from life, including: (a) thinking about first pregnancy, (b) thinking about another person, (c) meditation and (d) playing with grandchildren.

The time at which these thoughts were suggested are shown by vertical arrows on the graphs of FIG. 15A-B. It can be seen that typically after a brief delay of a few seconds, there is a clear change in the voltage characteristics such as amplitude or spectral characteristics. Such change shows that such measurements (including DC and low frequency AC together with high frequency AC) are capable of indicating a response to various psycho-emotional stimuli. Such measurements therefore have potential applications in lie detector machines and to psycho-immune measurements or self-confidence monitoring.
A. Imagination task in volunteer AM asked to imagine a) first pregnancy; b) to think about person A; c) imaging playing with smaller grandchild; d) recall successful meditation; e) think about person B.
B. Imagination task in volunteer LG asked to think about a) person A; b) person B.

Important to mention, that we performed similar “imagination experiments” with electrode pairs described in FIG. 1 applied to different body parts, for example, chest, abdomen area, under the liver, thyroid, on head, etc. These experiments showed that different body parts have different magnitude and character of reaction to different kinds of mental activity. This multi-electrode body mapping device can be a real basis for the psycho-immune status detector, lie detector, self-confidence detector or multi-level real time diagnostic device for organ functioning as a result of any kind of physical or mental activity. This research can put light of body mind interconnection and inter-influence.

Additionally to organ functional diagnostics, the same measuring system applied on classically defined charkas places can serve as a functional charka diagnostics as itself and as related to different kinds of activities. Defined in Indian, Tibetian or Chinese traditional medicine charkas and marmas places are anatomical places characterized by high density of bio-fluids flows and/or correspondently high density of energy transform and concentration gradients. Comparative anatomical analysis shows that most of anatomical elements forming these flows like blood vessels, lymph vessels, nerves, etc are forming spirals, because it corresponds to minimization of losses and also feat the requirement of maximally equal nutrient and gases supply.

FIG. 16A-16D are graphs showing experimental data generated by a sensing apparatus 200 of FIG. 2 for detecting glucose levels in different patients, according to an embodiment of the present invention.

In FIG. 16A, examples of raw data are shown and corresponding spectral analysis different blood glucose levels in humans. The first column shows voltage of first electrode and second electrode, where two electrodes were placed along the hand vein flow. Blood glucose level (BGL) was estimated by standard AccuCheck™.

First row: Data taken from normal person with BGL=75 mg/dL

Second row: Data taken from the same person after dinner with BGL=144 mg/dL

Third row: Data taken from diabetic patient with BGL=111 mg/dL

Forth row: Data taken from the same diabetic patient with BGL=173 mg/dL

In this figure, changes of voltage and voltage spectral characteristics of changes in the blood glucose level are displayed.

In FIG. 16B, there are shown examples of raw data and spectral analysis from an anesthetized male rat (weight 450 g.) for different blood glucose levels. The first column shows voltage of a first electrode and of a second electrode, where two electrodes were placed along the tail vein flow. Blood glucose level (BGL) was estimated by standard AccuCheck (Roche, Mannheim, Germany). For change in BGL the rat was injected IP with glucose/insulin.

First row: Data taken from anesthetized rat with BGL=146 mg/dL

Second row: Data taken from the same anesthetized rat with BGL=19 mg/dL

Similar to human data in rats one can also observe clear changes of voltage and its spectral characteristics with changes in the blood glucose level.

FIG. 16C shows the results of the following experiment: GlucoSat sensors were connected to an anesthetized rat and the signal was record for two hours detecting a blood glucose level of from 116 mg/dL to 318 mg/dL.

In this figure, as an example, four calculated GlucoSat parameters were plotted as a function of blood glucose level measured by AccuCheck (Roche, Mannheim, Germany). For each graph, correlation coefficients were calculated, as well as p-value.

Most correlations had a fit of close to 0.9, and all of them were significant at least at level 0.00001 (highly significant).

This model takes in account more then these four parameters, thus enabling to increase the accuracy and reliability even further.

FIG. 17 shows graphs displaying experimental data generated by a sensing unit 100 of FIG. 1 of the present invention wherein the device is used to investigate limb metabolism.

FIG. 17 shows the results of different voltage measurements, produced by the electrodes 108, 112 of the sensing unit 100 of FIG. 1. One wearable unit 420 of FIG. 4 comprising sensing apparatus 100, worn on each of all four limbs and corresponding DC and low and high frequency AC voltage changes were measured during contact of a hand to the left leg by an assistant (at about 65 seconds into the experiment); and later (at about 180 seconds into the experiment) with the volunteer heating his own hands using thought/imagination.

The mean voltage value measured as a result of limb metabolism itself carries important information about general blood supply and mean limb metabolism value. It can be used as a diagnostic of stagnation and swelling, peripheral arterial or vein disorders, or others metabolic activities, disorders or dysfunctions.

The dynamic changes of the measured signal pattern as a result of a reaction to any applied stimuli to an entity may be used as a functional diagnostic, reflecting not only static properties, as a mentioned hereinabove, but also dynamic properties, such as ability to react, to return to homeostasis or steady state values, hysteretic characteristics and other dynamic phenomena.

The perturbations seen in the figures are as a result of different applied stimuli, which can be used to demonstrate metabolic activities, disorders and dysfunctions, related to metabolism and blood flow change in the limbs.

The apparatus can be used for bio-feedback and for diagnostics. Furthermore, this figure shows new results that indicate that metabolism and reaction to the stimuli applied to one limb significantly affects all the other limbs. Furthermore, these experimental results support a recently developed theory that there is a coordinated interconnection between the limbs. This, in itself, has an enormous importance for the functional diagnostics and treatment of limbs in case of gangrene and amputation prevention, elimination of swelling, rehabilitation after injuries, functional training after amputation of one of the limbs and others.

FIG. 18 shows graphs exhibiting experimental data generated by a sensing apparatus 100 of FIG. 1 the present invention for local metabolism disorder diagnostics (in this case—melanoma).

Here unit 420 comprising sensing apparatus 100 was worn on a portion of a 53 year old male patient having diseased skin with an affected metabolism. The graph shows dynamic voltage change during a bio-resonance electromagnetic treatment.

For the first three minutes of the measurements, the patient was working by himself, i.e. using the device as a biofeedback system. At three minutes into the experiment, the patient fell asleep and an electromagnetic resonance treatment began wherein different resonance signals were used.

The change in voltage response seen in the curve of FIG. 18, at three minutes into the experiment when the resonance treatment began, validates the sensitivity of the electrode measurements to a change in local metabolism caused by the treatment. The device further monitored the patient's metabolism parameters during continuation of the treatment, which was suspended temporarily between 28-31 minutes and after 39 minutes. Again, the electrodes measure changes in the patient's local metabolism as seen in the response change shown in FIG. 18 at those times.

FIG. 19 shows outputs prior to and after providing an entity with a nutrient supplement, using a sensing apparatus 100 of FIG. 1 for determining some aspects of nutrient/supplement or drug metabolism, according to an embodiment of the present invention. FIG. 19 graphically shows experimental data generated by the present invention as a nutrient/supplement or drug metabolism tracking system. During this experiment, a 64 year-old male volunteer, took a nutrient supplement while the surface electrodes of apparatus 100 of the device were placed on his body at locations at which this supplement was expected to act.

There was a clear affect in the dynamic of mean voltage, in particular a 50 mV decrease, as a result of the supplement intake.

This indicates that the device can be used to track physiological changes in the body as a result of drug/supplement/food intake and thus it has application in pharmaco-dynamics, drug/supplement development, improvement of treatment protocols, diet programs and others.

FIG. 20 is a simplified flowchart 2000 showing postulated interactions between the brain and body in a mammal in response to a stimulus, according to an embodiment of the present invention.

In a stimulus providing step 2010, an entity, such as a mammal is provided with one or more stimuli. The stimuli may be, for example, a physical, a chemical, a psychological or another stimulus. In some experiments, the stimulus is a drug, a food or other stimulus.

In a sensing step 2020, the mammal senses the stimulus. The sensing may include use of one or more of the known six senses and sensing information is outputted to the brain and to the body.

In a body processing step 2030, some cell, organelle, organ or body processes ensue. For example, a muscle may contract, hair follicles may be erected, and heart rate and breathing rate may change.

In a body outputting step 2040, at least one output is affected. This output may be voluntary or involuntary. Examples of voluntary outputs include, but are not limited to, movement and speech. Involuntary outputs include reflexes, sweating, blinking and the like.

In a cognitive processing step 2050, in parallel to step 2030, the brain processors the sensing information from step 2020.

In a cognitive outputting step 2060, at least one cognitive output is produced. The output may include conscious and/or unconscious outputs. Conscious outputs include thoughts and emotions. Unconscious outputs include dreams and phobias.

As is shown in FIG. 20, there may be numerous interactions between cognitive processing step 2050, body processing steps 2030, cognitive output step 2060 and body output step 2040.

FIG. 21 is a simplified illustration of the outer surface layers including (skin) of a mammal. In FIG. 21, there is shown cross section of the normal skin that contains hypodermis, dermis and epidermis. Epidermis is relatively thin layer about 0.1-0.2 mm which content dead cells with skin fat and opened sweat gland and sebaceous ducts.

The skin contains also hairs that lay under skin surface. Keratin, elastin and hairs have a semi-conductive properties and create voltage under applied deformation or mechanical stresses. Potential formation also takes place between particles of epidemical layers.

Hair follicles and sebaceous glands such as sweat glands are dislocated inside dermis and connected with blood vessels capillary network. These glands and their ducts act as arrector pilli form lines of increased conductivity between skin surface and internal tissue. Skin surface secretes about at least 500 ml/day of sweat that contains about 1% of mainly electrolyte and other substances.

Hypodermis includes fat tissue which improves skin thermo isolation properties.

It is very important that dermis and hypodermis contains living cells surrounded by interstitial fluid. Therefore surface skin electrodes having relatively wide area first of all interact with interstitial liquid inside the body using lines of natural increased conductivity.

Moreover, skin surface can be also seen as a semi-permeable membrane through which our body produces gas exchange with the surroundings.

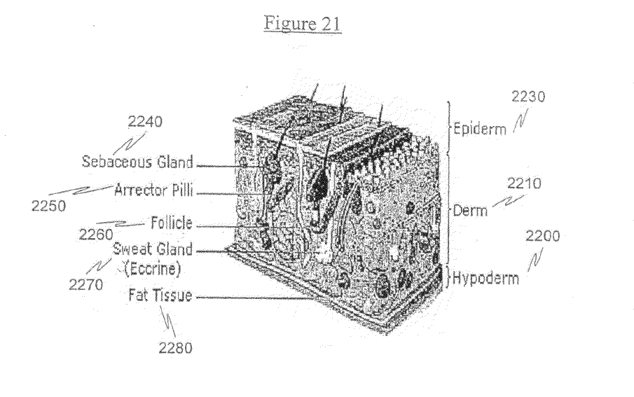

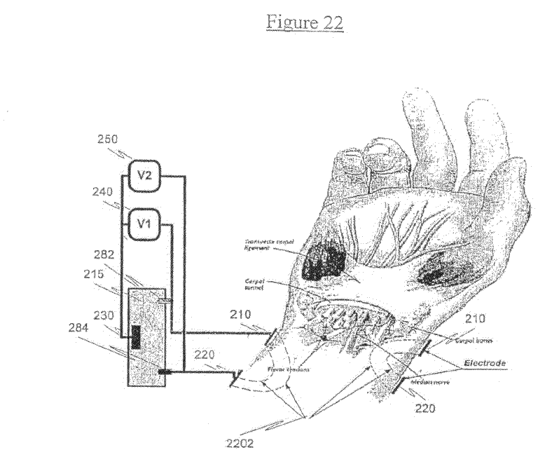

FIG. 22 is a simplified illustration of the action of a sensing apparatus 200 or 300 (FIG. 2 or 3) or in system 400 of FIG. 4 in measuring under-skin currents of a mammal; according to an embodiment of the present invention.

In any part of our body take place metabolic processes and corresponding metabolite transport which includes, as it is shown in FIG. 21, blood and lymph vessels and also diffusion and convection transport in interstitial fluids and inside cells.

There is always exists a concentration gradient inside tissue and between tissues and blood or lymph capillary vessels which needed for transport optimization. According to Nernst equation, any concentration change always is accompanied with voltage change; in addition, any electrolyte motion can be seen as a current. Therefore metabolite transport naturally cause bio-electricity part of which has to flow through applied to the skin our novel measuring system.

In FIG. 22, it is schematically illustrated, some of the possible ways of using a sensing apparatus, such as, but not limited to 200, 200A, 300, or 500 applied to the wrist of person. Two surface electrodes, such as, but not limited to, electrodes 210, 220 are applied on the skin surface in a bracelet manner (in this picture shown the hand cross section). The numbers in this figure correspond to the reference numerals of FIG. 2, wherein there is an electrolytic cell 280 filled with electrolyte 215 have two working electrodes 282, 284 and a reference electrode 230. Three electrolytic cell electrodes 282, 284, 230 are connected further to measuring unit including device of voltage measurement between working electrode and reference electrode 240, 250.

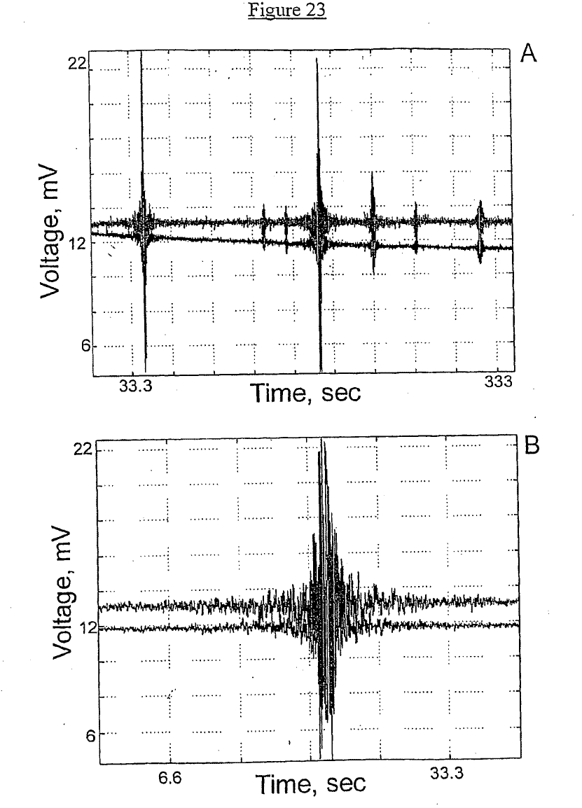

FIGS. 23A-23B are graphs of outputs relating to spontaneous muscle activity recorded by apparatus 200, according to an embodiment of the present invention.

FIG. 23 is an output relating to typical spontaneous muscle activity recorded by apparatus 200 from a person's right hand during the relaxation session.

In this experiment, a female volunteer (TM age 66) was lying on the mat motionless while she was lead through a deep relaxation session by professional yoga teacher.

The lower line indicates the measured potential from first surface electrode, while the upper line indicates measured potential from the second electrode. The measured signals were smoothed using standard Gaussian filter using Matlab functions.

FIG. 23A shows measured activity during about 250 sec of the relaxation experiment.

In FIG. 23B the typical spontaneous muscle activity is plotted in more detailed view at the scale of about 40 seconds.

Such a spontaneous muscle activity is an important measures feature by itself. This activity is further related to psycho-emotional state, nervous system state, cardiovascular supply and to a blood glucose level.

Apparatus 200, used for this experiment had the following features:

Surface electrodes 210, 220 were made from pure silver (99.99%), the same the ground surface electrode 260.

The area of each working electrode was 0.8×2.3=1.84 cm2

The distance D between working electrodes was 1.2 cm

The reference electrode was standard AgCl reference electrode (World Precision Instruments Ltd, EP2) and as electrolyte cell solution was use saturated KCl (Sigma) solution.

The measuring unit 290 comprises in this example two voltage measuring channels 240, 250 in NI multi-channel data acquisition card DAQPad-6016.

Some embodiments of the present invention relate to a device and method for measuring, recording and analyzing the electrical, magnetic, bio-mechanical, acoustic, metabolic activity of a biological being or parts thereof. The present device and method can be used to measure physiological parameters including blood glucose level, insulin sensitivity, nervous system state, cardiovascular function (including heart rate, blood viscosity, blood pressure, pulse wave area and pulse spectrum), other organ function (including the brain), tissue function, metabolic condition (including cancer diagnostics), and so on.

The term “biological being” is used herein and in the claims in its broadest sense and can include people, animals or plants—healthy or non-healthy. These beings need not be voluntary “patients”, for example in the case of terrorists, criminals, etc as will be discussed below. As the more common applications relate to people, and more particularly “patients”, the terms may be used interchangeably herein, without implying limitation of the scope of the present invention.

By one aspect thereof, the present invention provides a device for measuring physiological parameters of a biological being comprising: at least two spaced apart electrodes at least one of which is in contact with the biological being for providing a bio-potential measurement including a low frequency AC voltage and/or a DC voltage in which one of the at least two electrodes is a reference electrode providing a reference for the DC voltage, wherein the low frequency AC voltage and/or DC voltage of the bio-potential measurement is used to determine the physiological parameters.

By one aspect thereof, the present invention provides a method for measuring physiological parameters of a biological being comprising: (a) providing a device according to any of the embodiments herein; (b) contacting the device with a biological being, (c) measuring at least a DC voltage and/or a low frequency AC voltage of the biological being.

The combination of electrodes constituting the basic building block (BB) of the device is constituted by: two spaced apart electrodes at least one of which is in contact with the biological being for providing a bio-potential measurement including a low frequency AC voltage and/or a DC voltage in which one of the two electrodes is a reference electrode providing a reference for the DC voltage.

Additional sensors may be added to the basic building block or BB whereby the device may be used to either measure additional physiological parameters or allow the device to be used in more complicated settings. For example, the device may include a motion sensor whereby the biological being may be physically active while using the device and such activity may be taken into account during analysis of the measurements.

The term “low frequency AC voltage” refers herein to AC voltages generally below about 0.7 Hz (whereas present ECG, EMG and EEG devices use high frequency AC voltage—i.e. typically above 0.7 Hz).

The device can be adapted to be a comfortable, non-invasive, and inexpensive measuring, analysis and monitoring device, which may comprise or be used with a wireless multi-electrode system, and which can continuously detect physiological parameters and provide rapid output.

The biological beings may be described as a multi-dimensional space of entropy and interdependent parameters. In a first approximation it can be modeled as multi-parametric relaxation oscillator. Such an approach has enabled development of the present invention, which is a multi-parametric measurement system that allows multi-diagnostics with a number of specific applications.

Such an approach has enabled development of the present invention, which, according to particular embodiments is a dynamic, multi-parametric measurement device that allows simultaneous multi-diagnostics with a number of specific applications.

The device uses a combination of electrical sensors to obtain a DC voltage measurement and low-frequency AC measurements in addition to standard “high frequency” measurements (above 0.7 Hz) of the bio-potential as commonly measured by ECGs, EMGs and EEGs together with passive sensors (i.e. they do not input energy into the biological being).

By particular embodiments, the device further provides, singularly or in combination, a wireless ECG, EMG, EEG and brain hemisphere electrical activity sensor.

Different combinations of the developed sensors facilitate real time diagnosis of different illnesses including cancers, because illness and cancer are essentially a deviation in the local metabolism, and real time observation and measurement of pharmaco-kinetics and pharmaco-dynamics. It may be further used in pharmacological industry for medication development and individual adjustment existing treatment protocols. It may be used also for sport training, refining diet program, lie detector machines, chakra diagnostics, pregnancy and other types of tracking of physiology state diagnostics.

In addition to using combination of electrical sensors to obtain a DC voltage measurement and/or low-frequency AC measurement, the invention may further comprise standard “high frequency” measurements of the bio-potential as commonly measured by ECGs, EMGs and EEGs, together with passive physical sensors including accelerometer(s), mechanical sensors and acoustic and temperature sensors that measure and allow recording or electrical and acoustic activity, motion and shape and rate of pulse wave propagation.

According to particular embodiments, the device and method are used on a developed organism using thermodynamic theory which allows estimation of the blood glucose level, insulin sensitivity, nervous system and cardiovascular state including blood pressure and blood viscosity, local basic metabolism of inner organs and limbs and other parameters of a biological body's physiological state. Different combinations of the sensors facilitate real time diagnosis of different illness including cancers, because any illness and cancers are essentially is a deviation in the local metabolism.

The invention also allows real time observation and measurement of pharmacokinetics and pharmaco-dynamics.

It can be used as a blood glucose level monitor, limb metabolism monitor, wireless ECG device, pharmaco-dynamics tracking system, nervous activity sympathetic/parasympathetic index estimator, lie detector, local metabolism disorder diagnostic device and so on.

It is important to note that at least certain embodiments of the device may be used as a biofeedback systems in order to help a physician (or the patient himself), in real time, to choose or correct a health protocol or treatment and for medication development and treatment protocols including biofeedback for determining medication efficacy. It may be used also for sport training, refining diet program, lie detector machines, pregnancy and other types of tracking of physiology state diagnostics.

In particular embodiments, the electrodes provide a measurement of DC and AC voltages and time propagation of the electrical wave between any two electrodes. A reference electrode for providing a reference for the DC voltage measurement may be, for example, a saturated AgCl electrode.

These electrodes may be positioned along a limb (e.g. at a wrist or ankle) at a cross-section of the limb, or along the direction of blood flow, allowing an estimation of the hand/foot metabolic state at different blood glucose levels. The device could alternatively/further comprise an array of electrodes (e.g., a multi-electrode pad network), which can be placed on any part of the biological being and provide measurement of AC and DC voltages and time propagation of the electrical wave along of any direction of such electrode network.

The above-mentioned accelerometer can provide a measurement of body movement and detect tremors, for example that may take place under hypoglycemic conditions. This accelerometer may be connected to a microprocessor that allows an estimation of the complete motion accuracy and coordination and metabolic state of a patient under different psycho-immune conditions and at different blood glucose levels.

Note: acoustic and accelerometer sensors may have different spectral characteristics and so should typically be used with different contact and placement at the body parts. For example, a microphone may be placed on the body using air or another gas as a working conductive medium. This helps prevent high frequency oscillations that take place in solid and liquid media. On the other hand, accelerometers preferably use a liquid or semi-liquid contact with body surface. In this case all high frequency oscillations up to about 300 kHz may be measured and recorded by a transducer that allows observation of longitudinal and cross sectional waves, in the bones or other matter, which enables diagnosis and observation of joint and bone function, damage, wear, etc.

According to further embodiments of the present invention, the device/method may include a thermal regulation and disease condition and comprises at least two biocompatible temperature sensors, for example thermocouples or thermo-resistors, providing a measurement of skin and surrounding temperatures. The resultant temperature measurements allow an estimation of the thermo-regulation status under different external or internal conditions (e.g. disease) that affects blood flow, metabolism and glucose and insulin consumption.

The present invention may further include a programmable micro-processor, which allows personal calibration, for example, of the device as use as a glucose monitor. The programmable microprocessor allows necessary parameters to be input during periodic clinical examination of a diabetic patient. Such clinical examination may include an oral glucose tolerance test (OGTT). Measurement of the postprandial increase of blood glucose level may be used also for calibration. Calibration generally includes routine laboratory analyses of blood glucose levels and their correlation with physiological parameters.

In particular embodiments, the device may comprise a perspiration indicator and perspiration acidity combined sensor having at least two biocompatible electrodes made from different conductive materials, the perspiration constituting a conductive electrolyte so as to form a galvanic electricity source. The voltage and current depends on existence and acidity of the perspiration. Such an element does not need an external source of electricity thus increasing the life and reliability of the system.

The device can be actualized in different forms, for example:
1. A wrist-watch or anklet comprising a pair of pulse wave sensors, which provide data to produce a shape and time of propagation of the pulse wave between the sensors for use in determining limb metabolism, cardiovascular condition, nervous system measurement device; or a glucose monitoring device.
2. Belts or pads having sensors attached to the body for measuring local metabolism, brain activity, pharmacokinetics or pharmaco-dynamics; or for use in a lie detector machine or cancer diagnostics.
3. A wireless clothing article where all signals continuously in real time transmit signals (e.g. infra-red, ultra-sound, etc.) to a central receptor station (processor) allowing a person free movement for participating in sports or other daily activity.
4. A grip, rod, housing, surface, for instance to be touched, grasped and so on.
5. An invasive type device.
6. A combination of the above-mentioned forms.

The following theoretical thermodynamic analysis is the basis for all of the embodiments of the present device and method for measuring the above-mentioned physiological parameters. It is important to mention that although mainly diagnostic embodiments are discussed, the device may be used as a biofeedback system, for example, to help a physician, or the patient himself, in real time, to choose or correct a health protocol or treatment.
1) O₂ & CO₂ transport rate from capillaries into interstitial fluid is diffusion controlled (concentration gradient controlled, i.e. by the difference between the partial pressure of the gases in the interstitial fluid and arterial/venous capillaries)
2) Energy consumption and CO₂ production is essentially constant in a biological being's rest condition and it corresponds to the “basic metabolism”.
3) Increased metabolic activity may be caused by physical activity, the environment including thermal control by the body or by disease. It leads to increased formation of CO₂ and probably lactic acid. The increased CO₂ concentration affects the equilibrium reaction CO₂+H₂O═HCO₃⁻¹+H⁺ thereby affecting the electrolyte concentration (e.g. NaHCO₃, KHCO₃, CaCO₃).
4) Thus, an increase in metabolic intensity (e.g. due to disease) affects electrolyte concentration in the cells and interstitial fluid and so the liquid acidity (lower or higher pH), resulting in a change in redox potential. The metabolic intensity caused by disease, metabolic problems, etc, can be isolated from other causes by the application of appropriate algorithms.
5) For each 0.1 pH change there is a DC voltage change of approximately 6 m VDC for (i.e. a 0.1 pH increase results in a 6 m VDC increase).
6) Thus, gas and metabolite transport is accompanied by a DC potential difference.
7) Diseased cells are accompanied by increased metabolic activity and thus increased CO₂ concentration, and, as understood from the above, an increased DC voltage. Thus, a DC voltage can be used to indicate an unhealthy situation. However, that increased activity may merely be physical activity so that one must first correlate the DC change with physical activity to get a baseline.

The theory takes into account the principally different dynamic characteristics of glucose transport, and other metabolite transport, from blood vessel capillary walls to/from interstitial fluid. Note, diffusion has a linear rate dependence on concentration gradient and area of capillary walls to/from interstitial fluid and transport rate through cellular membranes depends on insulin concentration, receptor state, and carrier concentration and may be energy dependent, or non-dependent. The interstitial fluid partially compensates for local and/or temporal rate differences of the linear and non-linear parts of the metabolic transport and analysis of this dynamics allows estimation of the above listed and other important physiological parameters.

When a body's physiological parameters are in the normal range, the quality of physiological control is maximal and rate return to homeostasis is maximal also. When one or more of physiological parameters are out of the normal tolerance range, the quality of the body control is decreased and oscillations that are typical of such a non-tolerance range condition are observed.

Such a decrease in the quality of a body's control is understandable, because metabolite transport is a combination of linear and non-linear processes. For example, an athlete may use aerobic and anaerobic respiration despite the fact that anaerobic respiration is much less efficient. In this case muscles' and other tissues accumulate products of fermentation like lactic acid and other acids in interstitial fluid. Similar processes take place under intolerance of glucose or a disease condition.

Most metabolite transport through cellular membranes may be described by the well known Michaelis-Menten equation. It relates to non-linear processes that act in series with, in the present case, linear transport through blood and lymph capillaries. It is known that the restoration rate back to equilibrium is faster when the physiological parameters are within the tolerance range.

Deviation outside of normal physiological tolerance ranges causes a decrease in the quality of body control processes and is accompanied by over-regulation (oscillations). Provided by the present invention is dynamic on-line tracking of physiological changes allowing discrimination of different types of parameters deviations. Using the device and method with personal calibration, allows an individual mathematical model to be built for the determination of the blood glucose level, nervous system and cardiovascular state, pharmaco-kinetics and pharmaco-dynamics, etc.

An interesting example of such an approach results from a comparison of healthy cells and cancer cells. The more primitive metabolism of the cancer cells leads to increase in the Gibbs energy of these cells relative to the health cells, which are close to a normal homeostasis condition (i.e. not in a range of particularly low or particularly high metabolism). The polymorphic characteristics of cancer cells may be estimated as a differential change in the Gibbs energy divided by the Plank constant.

Regardless, the Gibbs energy is lower in cancer cells under the both too low or too high metabolic conditions. It is one reason why people reaching the end of the reproductive life-period have a higher probability of breast, prostate and uterus cancers.

It is very important to note also that the stability of cancer cells is more limited by an increase in entropy than healthy cells. Therefore particularly those (cancer) cells are more sensitive to hyperthermia, which is used today as an effective cancer therapy. However, hyperthermia cannot be effective under either too poor or too high metabolic conditions (this will be understood better with reference to FIG. 17, described below). This treatment can work if the patient is close to the normal homeostasis. For example, for women close to menopause it is important in addition to the hyperthermia to give a hormonal treatment which will normalize the blood circulation in the reproductive organs.

Another example supporting the theory used in the present invention is brain function during coordinated movement. It is well know that symmetric movements are easier in performance then non-symmetric ones.

The quality of the movement coordination is very important parameter of the nervous system. Strong emotional or physical stress decreases the quality of nervous control. Therefore the coordination itself in combination with other measurable physiological parameters may be used for the measurement of the psycho-immuno-physiological state. Examples where this measurement may be used is in checking people working in positions of great responsibility like airplanes, nuclear-power stations, etc., or as part of a regular health screening or to detect possible terrorists, criminals etc. who likely tend to exhibit emotional or physical stress, which may be measurable by the device of the present invention.

It should be understood that the sensing apparatus of FIGS. 1-3 can be used in arrays. These arrays may comprise many stand-alone units. Alternatively, the arrays of units of FIGS. 2-3 may be in a common electrolyte in one or more common electrolytic cells.

For clarity, a summary of the particular electrodes/sensors/meters required for different embodiments of the device of the present invention is shown in the Table 1 below.

TABLE 1
Required Sensors for Particular Embodiments of the Device

| | Sensors | | | | | |
|---|---|---|---|---|---|---|
| | Basic | | | | | |
| | Building | Pulse | | Thermo- | Accelero- | |
| | Block ** | wave | Acoustic | sensor | meter | |
| Device | must | sensors | Sensors | Optional | | Antenna |
| Glucose monitor | 1 | No * | No * | 1 | 1 | No |
| Nervous system | At least 1 | No * | No * | No * | No * | No |
| monitor | | | | | | |
| Wireless | At least 1 | No * | No * | No * | No * | No |
| ECG | | | | | | |
| Local metabolism | At least 1 | 2 | No * | At least 2 | No * | No |
| monitor | | | | | | |
| Limb metabolism | At least 1 | 8 | 4 | 4 | 4 | No |
| monitor | | | | | | |
| Psychological | At least 1 | 8 | 4 | 4 | No * | No |
| detector, | | | | | | |
| Lie detector | | | | | | |
| Pharmacokinetic; | At least 1 | 8 | At least 4 | At least 4 | At least 4 | No |
| pharmacodynamic | | | | | | |
| Geophysical | At least 1 | | At least 2 | At least 2 | At least 1 | At least 2 |
| processes detection | | | | | | |

No * = not required in the most simplistic embodiments of the device, however could be required in more complex embodiments.
** = BB = sensing apparatus 100, 200, 200A and 300
** Note: For all the listed applications appearing in the table, it is important to mention that at least one apparatus 200, 200A or 300 described in FIGS. 2 and 3, respectively, are essential for sensing the signals, while other listed sensors are optional and can be added or used according to specific algorithm for each sensor or device.

It should be noted that the implementation of the device being a BB as an ECG provides a compact, user friendly wireless ECG device. The fact that measurements are accomplished by an electrode with reference to a reference electrode allows voltage measurement without connecting an electrical loop through the biological being itself.

Thus present device and method allows monitoring of a patient's physiological (health/illness) condition by measurement, recording and analysis of the patient's functional physiological profile.

It is important to note that some of the above-mentioned parameters can be measured using merely DC voltage and/or low frequency AC voltage and do not necessarily need both.

### EXAMPLES

### Example 1

The non-invasive sensing unit (FIG. 1) was built comprising two surface electrodes (108, 112) each hating a surface contact area of 4 cm². The electrodes were made from aluminum foil, resistance was 9.4 kOhm (Tal-Mir electronics Ltd). The distance between the electrodes was 4 cm. For the better electrical contact, wet filter paper (not shown) with physiological solution (NaCl solution) was placed between the surface (skin) and the electrodes. An external resistor (116) was added to the system having a resistance of 9.4 kOhm, which was close to internal impedance of sensing system 100 (12 kOhm), which provided a maximal power signal in measurement system 102, corresponding to activities occurring under the skin, which provided a corresponding current.

It was calculated that the impedance between each electrode and the internal tissue under the surface was about 6 kOhm. This took into account that the initial impedance of the skin of this surface area was 25 kOhm/cm². Employing two electrodes, the total sensing system impedance between the electrodes and the body was about 12 kOhm.

The voltage measurement (102) was performed using National Instruments (NI) data acquisition card DAQPad-6016 connected to IBM laptop R51.

This unit 100 was employed to sense and measure activities occurring under skin, such as those described hereinabove for FIGS. 15, 17, 18 and 19.

### Example 2

The non-invasive sensing unit was built comprising two surface electrodes (210, 220) each having a surface contact area of 1. cm for rats. Reference electrode (230) was a 6 cm² for use with humans and 0.25 cm² for use with rats. These electrodes were made from pure silver (99.99% “Silver generator Ltd, USA”). The distance between electrodes was 1 cm for humans and 1.4 standard AgCl reference electrode (World Precision Instruments, Inc., EP2) immersed in saturated KCl solution (Sigma).

Electrolyte cell part of working electrodes (282, 284) were also made from pure silver (99.99% Chen Shmuel Chemicals Ltd.) with diameter 0.8 mm. It is important to mention that the ratio of surface of electrodes 210, 230 to the area of cell electrodes 282, 284 was at φcm², then the surface area of corresponding electrode 282 was less than 0.006 cm².

Inside electrolytic cell 280, the impedance between two cell electrodes was about 1 kOhm. The shunting unit 270 in this case was a standard resistor of 9.4 kOhm.

Ground electrode (260) has the same area as surface electrodes 210, 220, that is 1.6 cm² for humans and 0.25 cm² for rats respectively. Electrode 260 was likewise made of pure silver.

The measuring unit 290 comprised, in this example, two voltage measurement channels (240, 250) in a National Instruments (NI) data acquisition card DAQPad-6016 connected to IBM laptop R51.

Apparatus 200 was used for measuring and sensing as described hereinabove relating to the signal examples in FIGS. 16A, 16B and 16C.

### Example 3

FIG. 3 contains description of the same non-invasive sensing and measuring unit as FIG. 2 with additional reference electrode checking unit composed of immersed in the same saturated KCl electrolyte solution electrode CE1 (350) made from pure silver 99.99 and CE1 (360) made alloy 90% silver 10% gold.

R1 (340) is the same 9.4 kOhm, while R2 (370) 1 kOhm.

All voltage measurements (313,323,380,390) can be done using National Instruments (NI) data acquisition card DAQPad-6016 connected to IBM laptop R51 or any other voltage measuring system.

Difference in material composition of electrodes CE1 (350) and CE2 (360) causes voltage between the electrodes due to formation of galvanic pair. In the case of electrolyte evaporation, leakage or drying there is increase in internal impedance of the galvanic cell, therefore voltage measured on the impedance R2 (370) decreases from normal equal to stationary electrode potential.

1. A non-invasive sensing apparatus for sensing at least one parameter of an entity, comprising:
(i) at least two surface electrodes each having a contact surface adapted to be placed on a surface of the entity at corresponding at least two separate locations and further adapted to conduct electrical signals over a period of time from the at least two separate locations; and wherein two surface electrodes of the at least two surface electrodes are adapted to sense at least one characteristic of a current source under the surface of the entity;
(ii) an electrolytic cell isolated from the surface of the entity, comprising:
an electrolyte,
two cell electrodes in the electrolyte in electrical communication with the two surface electrodes adapted to sense the at least one characteristic;
wherein the electrolytic cell is adapted to be polarized responsive to the electrical signals so as to generate an electrolytic reaction, the reaction adapted to provide at least one electrical output corresponding to the electrical signals; and
(iii) a measuring unit, connected to the two cell electrodes, adapted to measure the at least one electrical output from at least one of the two electrodes so as to sense the at least one parameter.

2. A non-invasive sensing apparatus according to claim 1, further comprising a shunting unit adapted to provide a shunting resistance, wherein the shunting unit is coupled across the two surface electrodes adapted to sense the at least one characteristic, and wherein the shunting unit is electrically in parallel to the surface.

3. A non-invasive sensing apparatus according to claim 2, wherein the shunting unit comprises at least one resistor.

4. A non-invasive sensing apparatus according to claim 3, wherein the shunting resistance is at least 2 kiloOhm (KΩ).

5. A non-invasive sensing apparatus according to claim 2, wherein the shunting resistance is similar or equal to a resistance of the surface between the two separate locations of the two surface electrodes.

6. A non-invasive sensing apparatus according to claim 5, wherein the two separate locations are at least 5 mm apart.

7. A non-invasive sensing apparatus according to claim 1, wherein the contact surface is at least 0.5 cm².

8. A non-invasive sensing apparatus according to claim 7, wherein the contact surface is at least 1 cm².

9. A non-invasive sensing apparatus according to claim 1, further comprising a third cell electrode, not in contact with the surface of the entity, and wherein the third cell electrode is a reference electrode.

10. A non-invasive sensing apparatus according to claim 9, wherein the reference electrode is adapted to provide a standard potential of the electrolyte to the measuring unit.

11. A non-invasive sensing apparatus according to claim 1, wherein the two surface electrodes adapted to sense the at least one characteristic are made of different materials, and wherein said two surface electrodes are configured to form a galvanic pair.

12. A non-invasive sensing apparatus according to claim 1, wherein the two cell electrodes are of a first material and wherein the electrolyte is matched to the material of the two cell electrodes.

13. A non-invasive sensing apparatus according to claim 12, wherein the two surface electrodes are made of a second material.

14. A non-invasive sensing apparatus according to claim 13, wherein the second material is the same as the first material.

15. A non-invasive sensing apparatus according to claim 1, wherein the at least two surface electrodes comprise a third surface electrode.

16. A non-invasive sensing apparatus according to claim 15, wherein third surface electrode is a ground electrode, the ground electrode configured not to be in direct electrical contact with the electrolytic cell.

17. A non-invasive sensing apparatus according to claim 1, wherein the apparatus is configured to be housed in a housing suitable for placing on the skin of a mammal.

18. A non-invasive sensing apparatus according to claim 17, wherein the surface electrodes are biocompatible.

19. A non-invasive sensing apparatus according to claim 18, wherein the surface electrodes are made of a material selected from gold, silver, aluminum, platinum, a biocompatible semiconductor, a biocompatible metallic alloy and mixtures thereof.

20. A non-invasive sensing apparatus according to claim 1, wherein the measuring unit comprises at least one of a voltmeter, an A/D converter, a data acquisition card connected to a computer or processor, and an oscilloscope.

21. A non-invasive sensing apparatus according to claim 1, wherein the at least one electrical output is selected from a voltage, a current, a capacitance, an inductance and a resistance.

22. A non-invasive sensing apparatus according to claim 21, wherein the current is at least one of a direct current and alternating current.

23. A non-invasive sensing apparatus according to claim 22, wherein the alternating current has a frequency range of 0-30 MHz (megahertz).

24. A non-invasive sensing apparatus according to claim 1, wherein the at least one electrical output comprises:
a differential signal between at least one of the cell electrodes and the counter electrode; and
a differential signal between two of the cell electrodes;
a differential signal between at least one of the cell electrodes and at least one of the surface electrodes.

25. A non-invasive sensing apparatus according to claim 1, further comprising an electrolyte-checking module.

26. A non-invasive sensing apparatus according to claim 25, wherein the electrolyte-checking module comprises:
a first module electrode of a third material; and
a second module electrode of a fourth material; wherein the first and second module electrodes are in the electrolyte; and wherein the third and fourth material are different;
a module measuring unit in electrical communication with the first and second module electrodes; and
a resistance providing unit coupled to the first and second module electrodes; wherein the module measuring unit adapted to measure at least one of:
a) a differential signal between the first and second module electrodes; and
b) a differential signal between at least one of the first and second module electrodes and the reference electrode.

27. A non-invasive sensing apparatus for sensing at least a current source inside an entity, comprising:
(i) at least two surface electrodes each having a contact surface adapted to be placed on a surface of the entity at corresponding at least two separate locations and further adapted to conduct electrical signals over a period of time from the at least two separate locations responsive to at least one activity occurring under the surface of the entity,
(ii) an electrolytic cell isolated from the surface comprising:
an electrolyte,
at least three cell electrodes in the electrolyte, two of the cell electrodes in electrical communication with two of the at least two surface electrodes; wherein at least one of the cell electrodes is a reference electrode,
wherein the electrolytic cell is adapted to be polarized responsive to the electrical signals so as to generate an electrolytic reaction, the reaction adapted to provide at least one electrical output corresponding to the electrical signals; and
(iii) a measuring unit, connected to at least two of the cell electrodes, adapted to measure the at least one electrical output from at least two of the cell electrodes so as to sense at least the current source.

28. A system for non-invasive measurement of at least one parameter of a biological entity, comprising:
1) at least one sensing apparatus according to claim 1;
2) a processing apparatus adapted to process the at least one parameter measurement so at to provide at least one corresponding output;
3) a memory adapted to store at least one of:
the at least one parameter measurement; and
the at least one corresponding output;
4) at least one output device for outputting the at least one output.

29. A system according to claim 28 further comprising at least one of a contact sensor, a non-contact sensor, a pulse-wave sensor, a motion sensor, a temperature sensor, an acoustic sensor, an electromagnetic sensor, a pH sensor and a perspiration sensor.

30. A method for non-invasive sensing of at least one parameter of an entity, comprising:
(i) sensing at least one characteristic of a current source from under the surface of the entity over a period of time;
(ii) conveying at least one electrical signal corresponding to the at least one characteristic to an electrolytic cell so as to induce an electrolytic reaction over the period of time; and
(iii) measuring at least one electrical output of the electrolytic reaction so as to sense the at least one parameter over the period of time.

31. A method according to claim 30, wherein the entity is wherein the entity is selected from a biological entity, a structural entity, a geological entity, a chemical entity and a material entity.

32. A method according to claim 31, wherein the entity is a biological entity.

33. A method according to claim 32, wherein the at least one parameter is selected from a glucose level, a cardiovascular function, a blood pressure parameter, an organ function parameter, a tissue function parameter, a brain function parameter, a neural function parameter, a parameter associated with a metabolic activity, a parameter related to a limb metabolic condition, a pharmacokinetic drug parameter, a pharmaco-dynamic parameter; a psychological condition parameter, a temperature parameter, and a combination of thereof.

34. A method according to claim 31, further comprising processing the at least one electrical output over the period of time so as to provide corresponding output data.

35. A method according to claim 34, further comprising storing the corresponding output data.

36. A method according to claim 35, further comprising generating a trend of corresponding output data.

37. A method according to claim 36, further comprising analyzing the trend of the corresponding output data.

38. A method according to claim 37, further comprising fitting at least one of the corresponding output data and a trend of the corresponding output data to a model.

39. A method according to claim 38, further comprising analyzing at least one statistical fit responsive to the fitting step.

40. A method according to claim 39, further comprising providing a parameter result output relating to the at least one parameter responsive to the analyzing step.

41. A method according to claim 40, further comprising activating an alarm responsive to the parameter result output.

42. A method for non-invasive measurement of at least one parameter of a biological entity, comprising:
(i) completing an electrical circuit by placing at least two surface electrodes at two separate locations on a surface of the biological entity so as to conduct at least one electrical signal from the surface responsive to at least one activity occurring on and/or under the surface of the entity and so as to generate an electrolytic reaction responsive to the at least one electrical signal in an electrolytic cell comprising:
an electrolyte;
at least two cell electrodes in electrical communication with two of the at least two surface electrodes; wherein at least one of the cell electrodes is a counter electrode; and
(ii) measuring at least one of:
a differential signal between at least one of the cell electrodes and the counter electrode;
a differential signal between two of the cell electrodes; and
a differential signal between at least one of the cell electrodes and at least one of the surface electrodes;
over a period of time so as to provide at least one parameter measurement over the period of time corresponding to the at least one activity, and
(iii) processing the at least one parameter so as to provide at least one output relating to the at least one parameter.

43. A method according to claim 42, wherein the measuring step is performed continuously over the period of time.

44. A method according to claim 43, wherein the at least one parameter measurement comprises a plurality of parameter measurements.

45. A method according to claim 44, further comprising observing an event in the entity.

46. A method according to claim 45, further comprising measuring a plurality of post-event parameter measurements.

47. A method according to claim 46, further comprising comparing the plurality of post event parameter measurements with the plurality of parameter measurements so as to provide at least one event analysis for the entity.

48. A method according to claim 41, wherein the differential signal is selected from a voltage, a current, a capacitance, an inductance and a resistance.

49. A method according to claim 48, the current is selected from a direct current (DC) and an alternating current (AC).

50. A method according to claim 49, wherein the alternating current has a frequency range of 0-100 MHz (megahertz).

51. A method according to claim 42, wherein the at least one parameter is selected from a glucose level, a cardiovascular function, a blood pressure parameter, an organ function parameter, a tissue function parameter, a brain function parameter, a neural function parameter, a parameter associated with a metabolic activity, a parameter related to a limb metabolic condition, a pharmaco-kinetic drug parameter, a pharmaco-dynamic parameter; a psychological condition parameter, a temperature parameter, and a combination of thereof.

52. A method according to claim 42, wherein the two separate locations are at least 3 mm apart.

53. A system for monitoring at least one physiological parameter of a biological entity comprising:
(i) at least one sensing apparatus according to claim 1 for placing on the surface of the biological entity for sensing the at least one physiological parameter;
(ii) at least one transmitter for transmitting signals indicative of values of the at least one physiological parameter to a processing apparatus; and
(iii) a processing apparatus adapted to process the at least one parameter measurement so at to provide at least one corresponding output;
(iv) a memory adapted to store at least one of:
the at least one parameter measurement; and
the at least one corresponding output
(v) at least one outputting device for outputting the at least one output.

54. A non-invasive sensing apparatus for sensing at least one parameter of an entity, comprising:
a first electrode of one material; and
a second electrode of a second material; wherein the first material is different from the second material; and wherein
each electrode having an exterior surface adapted to be placed on a surface of the entity at two separate locations; and
a measuring unit, connected to both electrodes, adapted to measure at least one electrical output from at least one of the two electrodes so as to sense the at least one parameter.

55. A non-invasive sensing apparatus for sensing at least one internal parameter of an entity, comprising:
two electrodes, each having an exterior surface adapted to be placed on a surface of the entity at two separate locations, wherein the two electrodes are adapted to sense at least one characteristic of a current source under the surface of the entity;
a shunting unit adapted to provide a shunting resistance similar or equal to a resistance of the surface; wherein the shunting unit is connected to the two electrodes and is in parallel to the surface; and
a measuring unit, connected to both electrodes, adapted to measure at least one electrical output from at least one of the two electrodes so as to sense the at least one parameter.

56. A non-invasive sensing apparatus according to claim 55, wherein the two separate locations are at least 5 mm apart.

57. A non-invasive sensing apparatus according to claim 55, wherein the exterior surface is at least 0.5 cm².

58. A non-invasive sensing apparatus according to claim 55, wherein the two electrodes are made of the same material.

59. A non-invasive sensing apparatus according to claim 55, wherein the shunting unit comprises at least one resistor.

60. A non-invasive sensing apparatus according to claim 59, wherein the shunting resistance is at least 2 kiloOhm (KΩ).

61. A non-invasive sensing apparatus according to claim 55, wherein the at least one electrical output is selected from a voltage, a capacitance, an inductance, a current and a resistance.

62. A non-invasive sensing apparatus according to claim 55, wherein the current is at least one of a direct current and alternating current.

63. A non-invasive sensing apparatus according to claim 62, wherein the alternating current has a frequency range of 0-100 MHz (megahertz).

64. A non-invasive sensing apparatus according to claim 55, wherein the two electrodes, adapted to sense the at least one characteristic, are made of different materials, and wherein said two surface electrodes are configured to form a galvanic pair.

65. An array comprising a plurality of non-invasive sensing apparatus according to claim 1.
